(19) United States
(12) Patent Application Publication
(10) Pub. No.: US 2017/0185656 A1
(43) Pub. Date: Jun. 29, 2017

(54) Combining Search Results That Specify Software Application Functions

(71) Applicant: Quixey, Inc., Mountain View, CA (US)

(72) Inventor: Joseph NELSON, San Francisco, CA (US)

(21) Appl. No.: 15/086,001

(22) Filed: Mar. 30, 2016

Related U.S. Application Data
(60) Provisional application No. 62/272,217, filed on Dec. 29, 2015.

(51) Int. Cl. G06F 17/30; G06F 3/0482; G06F 3/0484

(52) U.S. Cl. CPC G06F 17/30554; G06F 3/04842; G06F 3/0482; G06F 17/30867

(57) ABSTRACT

Techniques include receiving a first search result from a search system, the result specifying a first state of a software application (app) and the state associated with a function performed based on a first parameter. The techniques further include displaying a first user-selectable link associated with the first result, the link configured to, upon being selected, set the app into the first state. The techniques still further include receiving a first user input and displaying a second user-selectable link associated with a second (e.g., previously stored) search result, the result specifying a second parameter. The techniques also include receiving a second user input selecting the first and second links and displaying a third user-selectable link associated with the first and second results, the link configured to, upon being selected, set the app into a second state associated with the function performed based on the second parameter.

### CROSS-REFERENCE TO RELATED APPLICATION

This application claims the benefit of U.S. Provisional Application No. 62/272,217 filed Dec. 29, 2015, which is hereby incorporated by reference in its entirety.

### TECHNICAL FIELD

This disclosure generally relates to the field of search, and more particularly to techniques for generating search results that correspond to states of software applications.

### BACKGROUND

In recent years, the use of computers, smartphones, and other Internet-connected computing devices has grown significantly. Correspondingly, the number of software applications (apps) available for such computing devices has also grown. Today, many diverse software apps can be accessed on a number of different computing devices, including smartphones, personal computers, automobiles, and televisions. These software apps may include business driven apps, games, educational apps, news apps, shopping apps, messaging apps, media streaming apps, and social networking apps. Because of the large number of software apps available today and the wide range of functionality they provide, computing device users often require the ability to search for and access specific software app functionality.

### SUMMARY

In one example, a method includes receiving, at a user device, a search query from a user, transmitting, using the device, the query to a search system, and, in response to transmitting the query, receiving, at the device, a first search result from the system. In this example, the first search result includes a first access uniform resource locator (URL) that specifies a first state of a software application (app). Also in this example, the first state is associated with a function performed based on a first parameter. The method further includes displaying, at the user device, a first user-selectable link associated with the first search result, the link configured to, upon being selected by a user input, cause the device to set the software app into the first state. The method still further includes, receiving, at the user device, a first user input from the user and, in response to receiving the input, displaying, at the device, a second, different user-selectable link associated with a second, different search result. In this example, the second search result specifies a second, different parameter. The method also includes receiving, at the user device, a second, different user input selecting the first and second user-selectable links from the user and, in response to receiving the input, displaying, at the device, a third, different user-selectable link associated with the first and second search results. In this example, the third user-selectable link is configured to, upon being selected by a user input, cause the user device to set the software app into a second, different state specified by a second, different access URL, where the second state is associated with the same function performed based on the second parameter.

In another example, a computing device includes a network interface component configured to communicate with a network, an input/output (I/O) component configured to receive a search query, a first user input, and a second, different user input from a user of the device, a display, one or more memory components configured to store computer-readable instructions, and one or more processing units configured to execute the instructions. The instructions, when executed by the processing units, cause the units to receive the search query from the user using the I/O component, transmit the query to a search system via the network using the network interface component, and, in response to transmitting the query, receive a first search result from the system via the network using the network interface component. In this example, the first search result includes a first access URL that specifies a first state of a software app. Also in this example, the first state is associated with a function performed based on a first parameter. The instructions further cause the processing units to display a first user-selectable link associated with the first search result using the display, the link configured to, upon being selected by a user input, cause the computing device to set the software app into the first state. The instructions still further cause the processing units to receive the first user input from the user using the I/O component and, in response to receiving the input, display a second, different user-selectable link associated with a second, different search result using the display. In this example, the second search result specifies a second, different parameter. The instructions still further cause the processing units to receive the second user input selecting the first and second user-selectable links from the user using the I/O component. The instructions also cause the processing units to, in response to receiving the second user input, display a third, different user-selectable link associated with the first and second search results using the display. In this example, the third user-selectable link is configured to, upon being selected by a user input, cause the computing device to set the software app into a second, different state specified by a second, different access URL, where the second state is associated with the same function performed based on the second parameter.

### BRIEF DESCRIPTION OF DRAWINGS

The details of one or more examples are set forth in the accompanying drawings and the description below. Other features, objects, and advantages will be apparent from the description and drawings, and from the claims.

FIG. 1 illustrates an example environment that includes a search system, one or more data sources, and one or more user devices that communicate via a network.

FIG. 2 illustrates an example user device in communication with a search system.

FIG. 3A is a functional block diagram of an example search system.

FIG. 3B is a functional block diagram of an example search module.

FIGS. 4A-4B illustrate example state records.

FIG. 5 is a flow diagram that illustrates an example method for generating search results specifying software application (app) functions using a search system.

FIG. 6 is a flow diagram that illustrates an example method for generating search results specifying software app functions using a user device.

FIGS. 7A-7J depict example graphical user interfaces (GUIs) that may be generated on a user device according to the present disclosure.

FIGS. 8A-8B are flow diagrams that illustrate example methods for combining search results specifying software app functions using a user device.

### DETAILED DESCRIPTION

The figures and the following description relate to example implementations by way of illustration only. It should be noted that from the following discussion, alternative implementations of the structures and methods disclosed herein will be readily recognized as viable alternatives that may be employed without departing from the scope of this disclosure.

The present disclosure generally relates to the field of search, and, more particularly, to techniques for generating and displaying search results that specify states of software applications (apps). Using the techniques described herein may, in some examples, improve user experience. According to the disclosed techniques, a user of a user device, such as a mobile computing device, may input a search query, such as a text string, into a search field of a search app executing on the device. The user may then cause the user device, namely the search app, to transmit the search query to a search system. The search system may receive the search query from the user device, generate one or more search results that each specify a state of a software app using the query, and transmit the results to the device. The user device may receive the search results from the search system and display each result to the user as a user-selectable link that includes text and/or image data describing the corresponding state of the software app.

For example, the user device may display a first user-selectable link associated with a first one of the search results. The first search result may specify a first state, such as a screen or a web page, of a particular software app. The first state may be associated with a function that is performed based on a first parameter. For instance, the function may include any of a variety of actions that may be performed as part of the first state, such as “make a restaurant reservation,” “read user reviews,” and “write a user review,” as some examples. The first parameter, in turn, may include any of an entity, such as a name of a specific business or a business franchise, a geographic location, a name of a product or service, or another parameter or parameter type on the basis of which the function is performed as part of the first state. In this example, the first user-selectable link generated by the user device for the first search result may be configured to, upon being selected by a user input, cause the device to set the software app into the first state.

After displaying the first user-selectable link, the user device may receive a first user input from the user and, in response to receiving the input, display a second, different user-selectable link associated with a second, different search result. The second search result may specify a second, different parameter, such as an entity, a geographic location, a name of a product or service, or another parameter or parameter type that is different than the first parameter. In some examples, the user device may have previously received the second search result from the search system in response to transmitting a search query to the system. Upon receiving the second search result, the user device may have displayed the result to the user as the second user-selectable link and, in response to receiving a user input from the user, stored the result and/or link. In these examples, upon receiving the first user input from the user, the user device may retrieve the stored second search result and/or second user-selectable link.

The user device may further receive a second, different user input selecting the first and second user-selectable links from the user and, in response to receiving the input, display a third, different user-selectable link associated with the first and second search results. Specifically, the second user input may be configured to select the first and second user-selectable links to combine the links, thereby generating the third user-selectable link. The third user-selectable link may be configured to, upon being selected by a user input, cause the user device to set the software app associated with the first search result into a second, different state. The second state may be associated with the same function as that which is associated with the first state, such as any of “make a restaurant reservation,” “read user reviews,” and “write a user review.” However, the function associated with the second state may be performed based on the second parameter specified by the second search result that is different than the first parameter.

In this manner, the techniques of the present disclosure may, in some examples, improve the user's experience by enabling the user to access additional functionality associated with the search results received from the search system. Specifically, the techniques may enable the user to combine multiple ones of the search results each having particular functionality into a new search result that provides functionality that is different from that of each combined result.

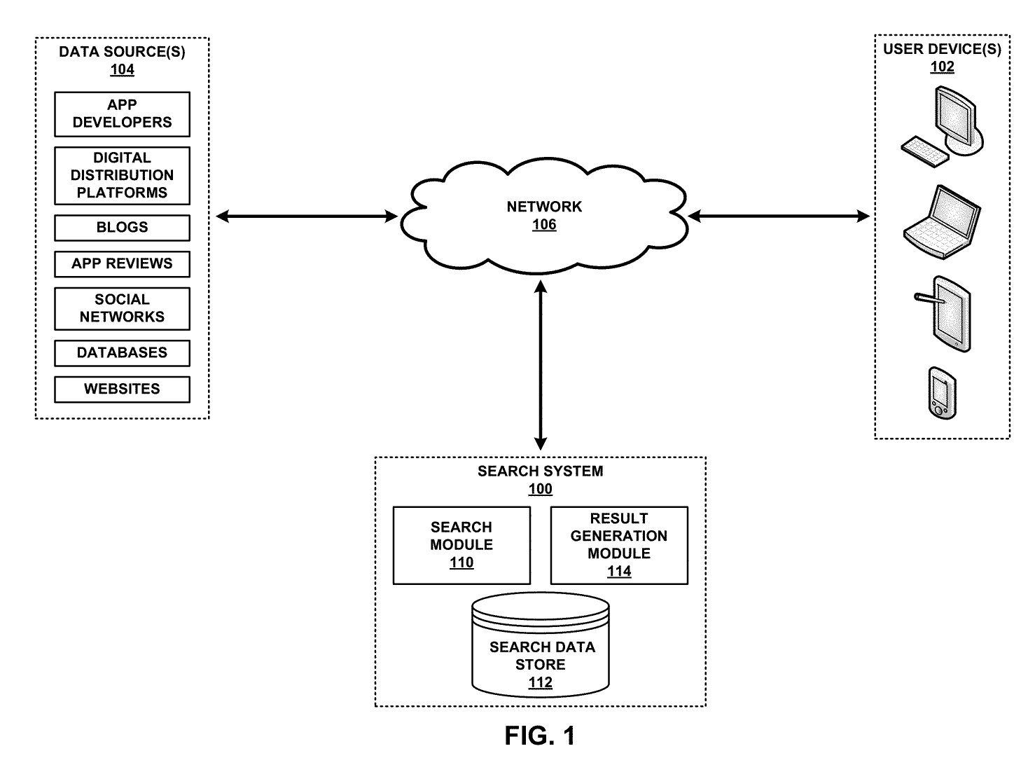

FIG. 1 illustrates an example environment that includes a search system 100 and one or more user devices 102 and data sources 104 that communicate via a network 106. The network 106 through which the above-described systems, devices, and sources communicate may include any type of network, such as a local area network (LAN), a wide area network (WAN), and/or the Internet. As shown in FIG. 1, the search system 100 includes a search module 110, a search data store 112, and a result generation module 114, which are described in greater detail herein. In the example of FIG. 1, the search system 100 receives a search query from one of the user device(s) 102 and generates one or more search results in response to receiving the query. Specifically, the search system 100 generates the search results based on the search query and information included in one or more state records stored in the search data store 112. In this example, each state record may specify a state of a software app. In particular, each state record may include one or more access uniform resource locators (URLs) that enable the user device(s) 102 to access the state specified by the record. The search system 100 transmits the access URLs included in the state records to the user device 102 as part of the search results, as described herein. The state records may also include state information (SI), such as text, and other data, such as state identifiers (IDs), which the search system 100 may use to identify the records in the search data store 112, as also described herein. The search system 100 transmits the search results, including the access URLs, to the user device 102, which displays the results to a user of the device 102 as one or more user-selectable links that include the access URLs.

To generate the search results, the search module 110 may identify one or more state records included in the search data store 112 based on the search query. Initially, the search module 110 may optionally analyze the search query. The search module 110 may then identify the state records using the search query (e.g., the analyzed search query). For example, the search module 110 may identify the state records based on matches, such as text matches, between terms of the search query and terms of information, such as SI and/or state IDs, included in the records. The search module 110 may further process the identified state records (e.g., generate a result score for each record, thereby ranking the records). For example, the search module 110 may determine how well the identified state records match the search query. The search module 110 may then select one or more of the identified state records that best match the search query (e.g., select one or more of the records having the largest one or more result scores). The search module 110 may subsequently transmit indications, such as state IDs, of the selected state records to the result generation module 114. The result generation module 114 may receive the indications of the state records selected by the search module 110 from the search module 110 and identify the records in the search data store 112 using the received indications. The result generation module 114 may then select one or more access URLs from the identified state records and transmit the selected access URLs to the user device 102 as the search results.

In some examples, the result generation module 114 may transmit additional information to the user device 102 along with the access URLs. For example, as described herein, the search module 110 may generate result scores for the state records from which the result generation module 114 selects the access URLs (e.g., using values of various metrics associated with the persons, places, or things described by the records and/or any number of features associated with the search query). As such, each access URL may be associated with a result score that indicates an order, or rank, of the access URL relative to one or more other ones of the access URLs. In some examples, the result generation module 114 may transmit the result scores associated with the access URLs and the corresponding state records to the user device 102 along with the access URLs. Additionally, or alternatively, the result generation module 114 may transmit display data, such as text and/or image data, associated with the access URLs and the corresponding state records to the user device 102 along with the access URLs.

Upon receiving the search results from the search system 100, the user device 102 may display the results to the user as one or more user-selectable links. As described herein, each search result may include an access URL that specifies a state of a software app. As also described herein, the state may be associated with one or more functions, or actions, such as making a restaurant reservation, reading user reviews, and writing a user review, that are each performed based on one or more parameters as part of the state. As further described herein, the parameters may include entities, such as names of specific businesses or business franchises, geographic locations, names of products or services, or other parameters or parameter types.

In this disclosure, a software app may refer to computer software that causes a computing device to perform a task. In some examples, a software app may be referred to as an “app” or a “program.” Example apps include word processing apps, spreadsheet apps, messaging apps, media streaming apps, social networking apps, and games. Apps can be executed on a variety of different computing devices. For example, apps can be executed on mobile computing devices, such as smartphones, tablets, and wearable computing devices (e.g., smart watches, fitness bands, and headsets, such as smart glasses). Apps can also be executed on other types of computing devices having other form factors, such as laptop computers, desktop computers, and other consumer electronic devices (e.g., smart home appliances, home networking devices, and home automation devices). In some examples, apps may be installed on a computing device prior to a user purchasing the device. In other examples, the user may download and install apps on the computing device after purchasing the device. A native app, as used herein, may refer to an app that is installed and executed on a user device. A web-based app, in turn, may refer to an app that is accessible from a user device via a web browser app.

In some examples, the functionality of an app may be accessed on the computing device on which the app is installed. Additionally, or alternatively, the functionality of an app may be accessed via a remote computing device. In further examples, all of an app's functionality may be included on the computing device on which the app is installed. Such apps may function without communication with other computing devices (e.g., via the Internet). In additional examples, an app installed on a computing device may access information from other remote computing devices during operation. For example, a weather app installed on a computing device may access the latest weather information via the Internet and display the accessed information to the user. In still other examples, an app, such as a web-based app, may be partially executed by a user's computing device and partially executed by a remote computing device. For example, a web-based app may be executed, at least in part, by a web server and accessed by a web browser app of a user's computing device. Example web-based apps include web-based email sites, online auction sites, online retail sites, and other websites.

An access URL, as used herein, may include any of a native app access mechanism (AM) (hereinafter, “AAM”) and a web AM (hereinafter, “WAM”). As such, a user device 102 of the present disclosure may use an access URL to access the functionality provided by a native or web-based app. For example, a user of the user device 102 may select a user-selectable link that includes the access URL to access the functionality of the native or web-based app.

An AAM may be a string that references a native app and indicates one or more operations for a user device 102, or the app, to perform. If a user of the user device 102 selects a user-selectable link that includes the AAM, the device 102 may launch the native app and perform the operations (e.g., cause the app to perform the operations). In other words, the user selecting the user-selectable link may cause the user device 102 to launch the native app and set the app into a state that corresponds to the operations (e.g., a state in which the app displays a graphical user interface (GUI) or a screen). As a result, the native app may be configured to display one or more products, services, or vendors, to the user via a display device. In this manner, the AAM may specify the state of the native app. The state, in turn, may refer to the operations indicated by the AAM and/or the outcome of the native app performing the operations in response to the user selecting the user-selectable link including the AAM.

A WAM may include a resource ID referencing a web resource (e.g., a page of a web-based app, or website). For example, the WAM may include a URL, such as a web address, used with the hypertext transfer protocol (HTTP). If a user of a user device 102 selects a user-selectable link including the WAM, the device 102 may launch a web browser app included on the device 102 and retrieve the web resource referenced by the resource ID. Stated another way, if the user selects the user-selectable link, the user device 102 may launch the web browser app and access a state, such as a web page, of a web-based app or website, specified by the WAM. In some examples, a WAM included in a state record along with an AAM may specify a state of a web-based app that is equivalent or analogous to a state of a native app specified by the AAM.

In some examples an AAM may be associated with an app download mechanism (ADM). An ADM may specify a location, such as a digital distribution platform like Google Play® by Google Inc., where a native app may be downloaded (e.g., a native app referenced by an AAM). In some examples, a state record may include an ADM along with an AAM (and, e.g., a WAM). In these examples, the ADM may specify a location, such as a digital distribution platform, from which a native app referenced by the AAM may be downloaded.

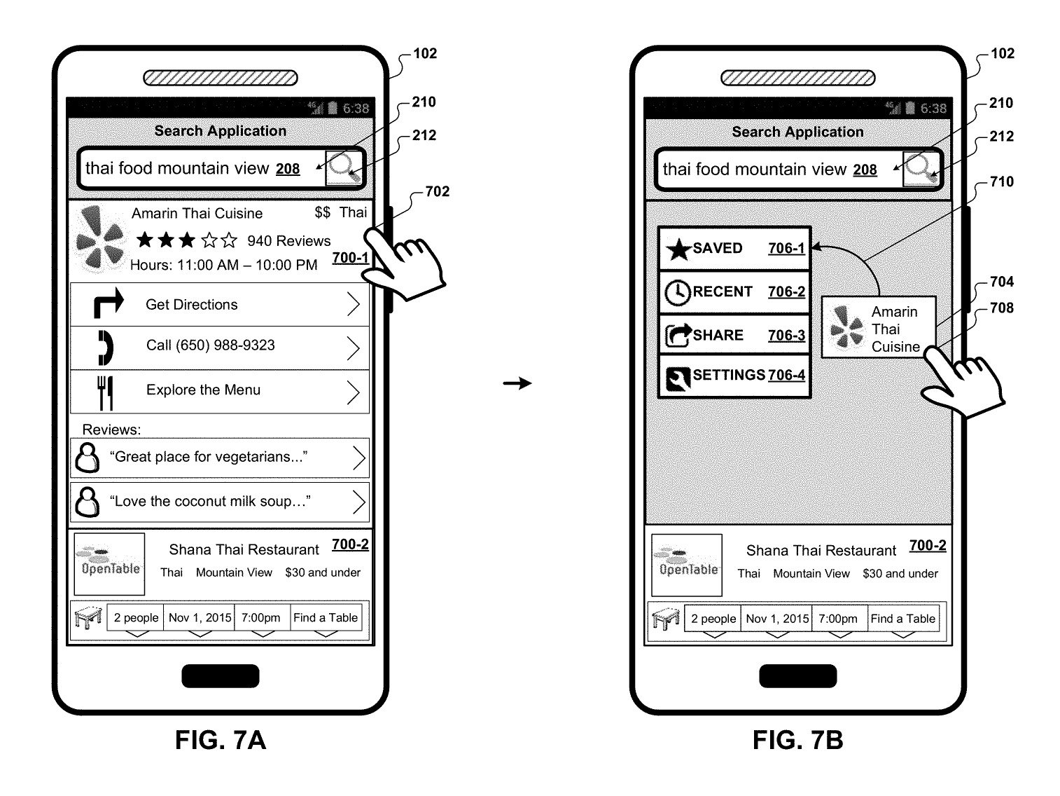

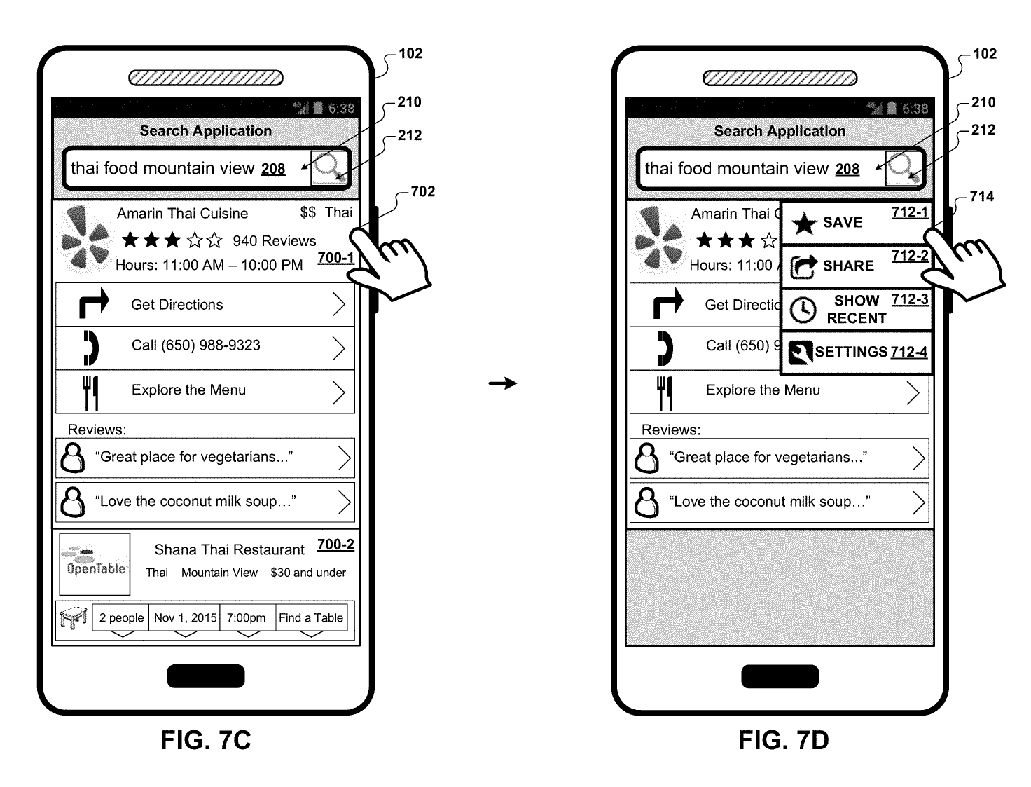

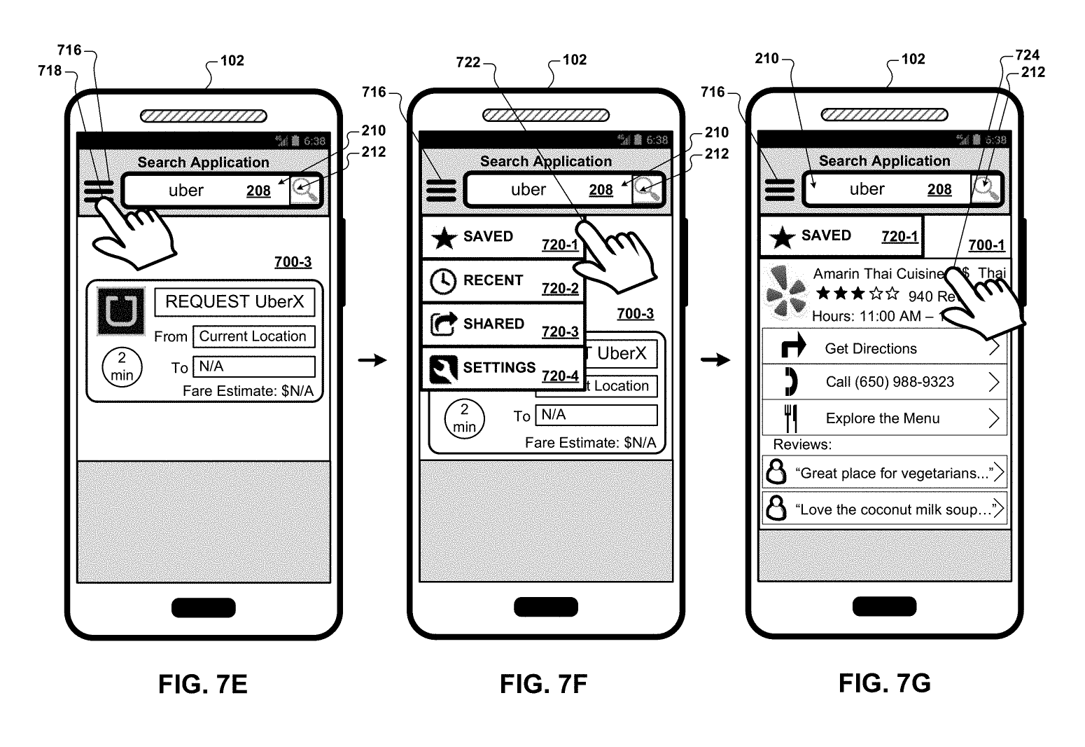

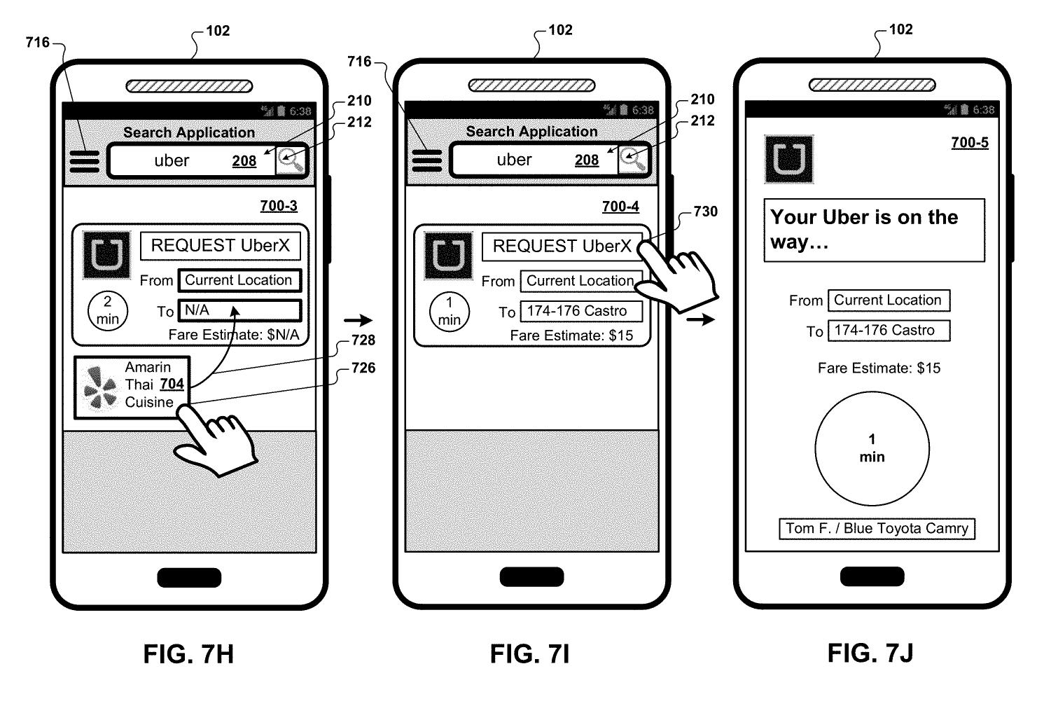

According to the techniques described herein, the user device 102 may receive a first one of the search results from the search system 100. The first search result may include a first access URL, such as an AAM or a WAM, that specifies a first state of a software app, such as a native or web-based app. The first state may be associated with a function that is performed based on a first parameter. The user device 102 may display a first user-selectable link associated with the first search result. The first user-selectable link may be configured to, upon being selected, such as touched, pushed, or clicked on, by a user input, cause the user device 102 to set the software app into the first state. The user device 102 may subsequently receive a first user input from the user and, in response to receiving the input, display a second, different user-selectable link associated with a second, different search result. The second search result may specify a second, different parameter. In some examples, the first user input may select the first user-selectable link or a GUI element other than the link. As a specific example, the first user input may include one or more user interactions with a user menu displayed at the user device 102, as described with reference to FIGS. 7E-7G. In this example, the user interactions may be configured to cause the user device 102 to display the second user-selectable link.

The user device 102 may further receive a second, different user input selecting the first and second user-selectable links from the user and, in response to receiving the input, display a third, different user-selectable link associated with the first and second search results. In some examples, the second user input may select the first and second user-selectable links. In other examples, the second user input may select one or more GUI elements other than the first and second user-selectable links, thereby causing the user device 102 to select the links. As a specific example, as described with reference to FIGS. 7G-7H, the second user input may include one or more user interactions with a user menu displayed at the user device 102 that are configured to cause the device 102 to select the first and second user-selectable links. The third user-selectable link may be configured to, upon being selected, such as touched, pushed, or clicked on, by a user input, cause the user device 102 to set the same software app into a second, different state specified by a second, different access URL. The second state may be associated with the same function as that of the first state. However, in the second state, the function may be performed based on the second parameter specified by the second search result.

In some examples, any of the first and second parameters may each include an entity corresponding to a name of a particular business, such as a vendor, and/or a specific business franchise. In other examples, any of the first and second parameters may each correspond to a geographic location. In still other examples, any of the first and second parameters may each correspond to a name of a product or service. In additional examples, the first and second parameters may correspond to other types of parameters (e.g., one or more text strings, alphanumeric strings, numeric values, symbolic characters, and/or any other information).

In some examples, the first search result may specify the first parameter. For example, the first access URL may include the first parameter in a field or a parameter placeholder of the URL configured to include the parameter. In other examples, the first search result may not specify the first parameter. For example, the field or parameter placeholder of the first access URL may be empty or include a default parameter that is different than the first parameter. In these examples, the user may specify the first parameter within the first search result by providing a user input to the user device 102 (e.g., by interacting with the first user-selectable link displayed at the device 102).

In some examples, the second search result may include a third, different access URL, such as an AAM or a WAM, that specifies a third, different state of a software app, such as a native or web-based app (e.g., the same software app as that associated with the first search result, or a different software app). In these examples, the third state may be associated with a function that is performed based on the second parameter (e.g., the same function as that associated with the first state, or a different function). Also in these examples, the second user-selectable link may be configured to, upon being selected, such as touched, pushed, or clicked on, by a user input, cause the user device 102 to set the software app associated with the second search result into the third state, as described with reference to the first search result. In other examples, the second search result may include or be associated with other content that specifies the second parameter (e.g., a native app, a web page, a document, and/or a media file).

In some examples, the search query may be a first search query. In these examples, for instance, at an earlier point in time prior to receiving the first search query, the user device 102 may receive a second, different search query from the user. The user device 102 may transmit the second search query to the search system 100 and, in response to transmitting the query, receive the second search result from the system 100. The user device 102 may display the second user-selectable link associated with the second search result. The user device 102 may then receive a third, different user input from the user and, in response to receiving the input, store the second search result and/or the second user-selectable link (e.g., at a local storage location and/or a remote data store). In these examples, the user device 102 displaying the second user-selectable link in response to receiving the first user input, as described herein, may include the device 102 initially retrieving the stored second search result and/or link. In other examples, the user device 102 may receive the second search result and/or the second user-selectable link from another source (e.g., from another one of the user device(s) 102).

In some examples, the second user input selecting the first and second user-selectable links may include the input selecting, such as touching, pushing, or clicking on, the second user-selectable link, so-called “dragging” the second user-selectable link toward the first user-selectable link, and so-called “dropping” the second user-selectable link onto the first user-selectable link. In other examples, the second user input selecting the first and second user-selectable links may include the input substantially simultaneously selecting, such as touching, pushing, or clicking on, the links. In still other examples, the second user input may include one or more user interactions with a user menu displayed at the user device 102 that are configured to select the first and second user-selectable links. In further examples, the second user input may select the first and second user-selectable links using any number of various other techniques (e.g., the input may correspond to a user gesture that select the links).

In some examples, the first user-selectable link may include a portion that is associated with the first parameter (e.g., an area of the link that describes the parameter using text and/or image data). In these examples, the second user input selecting the first user-selectable link may include the input selecting the portion (e.g., touching, pushing, or clicking on the portion). As a specific example, the second user input may select the second user-selectable link, drag the second user-selectable link toward the first user-selectable link, in a similar manner as previously described, and drop the second user-selectable link substantially onto the portion.

In some examples, the user device 102 may further determine whether the software app includes the second state. As one example, to make this determination, the user device 102 may perform a search for the second state in a data store associated with the software app. In this example, the data store may correspond to a local storage location included on the user device 102 and/or a remote data store (e.g., using so-called “cloud” storage). As another example, to make this determination, the user device 102 may perform a search for the second state in the software app executing on the device 102. As still another example, to make this determination, the user device 102 may query an app programming interface (API) associated with the software app to determine whether the app includes the second state. Additionally, or alternatively, to make this determination, the user device 102 may query the search system 100 to determine whether the system 100 includes a state record that specifies the second state.

In some examples, the user device 102 may further display a GUI element that indicates whether the software app includes the second state to the user. In other words, the GUI element may indicate to the user whether the first and second search results and the corresponding first and second user-selectable links may be combined. For example, the user device 102 may display the GUI element as part of one or more of the first and second user-selectable links (e.g., for each link, within the visual boundary of the link). As one example, the user device 102 may, in the event the software app includes the second state, display a highlighted version of at least the first user-selectable link of the first and second user-selectable links. In this example, the user device 102 may further, in the event the software app does not include the second state, display an unmodified version of each of the first and second user-selectable links. As another example, the user device 102 may, in the event the software app includes the second state, display an unmodified version of each of the first and second user-selectable links. In this example, the user device 102 may further, in the event the software app does not include the second state, display a grayed out version of at least the first user-selectable link of the first and second user-selectable links. As still another example, the user device 102 may, in the event the software app includes the second state, display a highlighted version of at least the first user-selectable link of the first and second user-selectable links. In this example, the user device 102 may further, in the event the software app does not include the second state, display a grayed out version of at least the first user-selectable link of the first and second user-selectable links. In general, the user device 102 may display any combination of highlighted and grayed out ones of the first and second user-selectable links, or components thereof (e.g., portions of the links associated with the first and/or second parameters). In other examples, the user device 102 may display the GUI element at a location outside of the first and second user-selectable links (e.g., as part of a header or another GUI component).

In some examples, the user device 102 may display the GUI element after displaying the second user-selectable link to the user and otherwise refrain from displaying the element. In other examples, the user device 102 may display the GUI element while receiving the second user input and otherwise refrain from displaying the element. In still other examples, the user device 102 may display the GUI element prior to and/or after receiving the second user input.

In some examples, the GUI element may indicate that the second parameter associated with the second search result, such as a particular geographic location, has the same type as or matches the first parameter associated with the first search result, such as another geographic location. As a specific example, the GUI element may correspond to highlighted first and second user-selectable links, or to highlighted portions thereof, such as text and/or images that are associated with the first and second parameters, to indicate that the parameters match. In other examples, in cases where the first search result is associated with one or more additional parameters that match the second parameter, the GUI element may correspond to multiple highlighted portions of the first user-selectable link associated with the first parameter and the additional parameters. In these examples, the user may specify which of the parameters associated with the first search result is to be specified or replaced by the second parameter. For example, the user may select, drag, and drop the second user-selectable link or a minimized version thereof onto one of the highlighted portions of the first user-selectable link that corresponds to one of the parameters associated with the first search result that the user wishes to specify or replace by the second parameter. In other examples, the GUI element may indicate that the first parameter, for example, an entity, associated with the first search result does not have the same type as or does not match the second parameter. For example, the GUI element may correspond to removed, grayed out, or otherwise obscured first and second user-selectable links or portions thereof, such as text and/or images that are associated with the first and second parameters, to indicate that the parameters do not match. In cases where the first search result is associated with one or more additional parameters that do not match the second parameter, the GUI element may correspond to multiple removed, grayed out, or otherwise obscured portions of the first user-selectable link associated with the first parameter and the additional parameters. In these examples, the user may select, drag, and drop the second user-selectable link or a minimized version thereof onto a portion of the first user-selectable link that is not removed, grayed out, or otherwise obscured and that corresponds to one of the parameters associated with the first search result that the user wishes to specify or replace by the second parameter. Alternatively, the user device 102 may automatically determine which of the parameters associated with the first search result is to be specified or replaced by the second parameter. For example, the user device 102 may select an unspecified one of the parameters associated with the first search result that matches the second parameter to be specified by the second parameter (e.g., select a parameter that corresponds to a blank field in the first access URL).

In additional examples, the GUI element may correspond to another visual indication of parameter compatibility. For example, the GUI element may correspond to the first user-selectable link being visually partitioned into a number of regions (e.g., using a grid). Each region may be associated with one of the parameters associated with the first search result, including the first parameter, that match the second parameter. In this example, the user may select, drag, and drop the second user-selectable link or a representation thereof, such as a minimized version, onto any of the regions of the first user-selectable link, thereby specifying which of the matching parameters associated with the first search result, including the first parameter, is to be specified or replaced by the second parameter.

In some examples, to display the third user-selectable link, the user device 102 may display the link in place of the first user-selectable link. In other words, the user device 102 may replace the first user-selectable link with the third user-selectable link. In other examples, to display the third user-selectable link, the user device 102 may update the first user-selectable link to resemble the third user-selectable link. In still other examples, the user device 102 may display both the first and third user-selectable links (e.g., adjacent to one another in a list).

In some examples, the user device 102 may generate the second access URL based on the first access URL and the second parameter. As a specific example, the user device 102 may insert the second parameter into a field, or a parameter placeholder, of the first access URL configured to include the first parameter. In this example, the field may or may not include the first parameter. For example, the user device 102 may insert one or more terms, such as text, associated with the second parameter into the field. In some examples, the user device 102 may select and/or format the terms using rules and/or guidelines associated with the first access URL. In other examples, the user device 102 may first generate a modified version of the search query based on the first access URL and the second parameter. For example, the user device 102 may lengthen, shorten, and/or rearrange one or more terms of the search query based on the first access URL and the first parameter. As a specific example, the user device 102 may incorporate one or more terms, such as text, associated with the first access URL and the second parameter into the search query. The user device 102 may then transmit the modified version of the search query to the search system 100 and, in response to transmitting the modified version, receive a third, different search result from the system 100 that includes the second access URL.

In some examples, one or more of the first and second user inputs may each correspond to a finger contact input received at a capacitive touchscreen of the user device 102, a pressure input received at a pressure-sensitive display of the device 102, and/or a cursor selection input received via one or more of a computer mouse and a trackpad of the device 102. In other examples, one or more of the first and second user inputs may each correspond to one of a momentary input having a relatively short time duration and a prolonged input having a relatively longer time duration than that of the momentary input. In still other examples, one or more of the first and second user inputs may each correspond to one of a shallow input having a relatively small depression depth with respect to a pressure-sensitive display of the user device 102 and a deep input having a relatively large depression depth with respect to the display than that of the shallow input. In further examples, one or more of the first and second user inputs may each correspond to one of a first gesture with respect to a display of the user device 102 and a second, different gesture with respect to the display.

The search query may include text, numbers, and/or symbols, such as punctuation, entered into the user device 102 by the user. In some examples, the user may have entered the search query into a search field, or a so-called search “bar” or “box,” of a search app executing on the user device 102. As described herein, the search app may be a native app dedicated to search, or a more general app, such as a web browser app. For example, the user may have entered the search query using a touchscreen keypad, a mechanical keypad, and/or via speech recognition techniques. In these examples, upon entering the search query, the user may have caused the search app to transmit the query to the search system 100 by further interacting with the app. In additional examples, the user may have entered the search query into the search app using various other techniques (e.g., so-called “autosuggest” or “autocomplete” techniques). In further examples, the search query may be generated or selected based on an interaction between the user and the user device 102, such as in response to the user selecting a link that corresponds to a predefined search query within an app executing on the device 102.

In some examples, the user device 102 may transmit additional data to the search system 100 along with the search query. The search query and the additional data may be referred to herein as a “query wrapper.” The additional data may include geo-location data associated with the user device 102. The additional data may also include platform data for the user device 102, such as a type and/or a version, an operating system (OS), and/or a web browser app associated with the device 102. The additional data may further include an identity of the user, such as a username, partner specific data, and/or other data, such as indications of one or more native apps that are installed on the user device 102. The user device 102 may transmit the query wrapper to the search system 100. The search system 100 may receive the query wrapper from the user device 102 and use the search query and, optionally, the additional data included in the wrapper to generate the search results and provide the results to the device 102.

In some examples, the search system 100 may transmit the search results, including the access URLs, to the user device 102 with additional data. For example, the search system 100 may transmit display data, such as text and/or image data, which the user device 102 may use to generate the user-selectable links for the access URLs included in the search results. Each user-selectable link may include a portion of the display data that the user of the user device 102 may select (e.g., touch, press, or click on). Each user-selectable link may also be associated with one of the access URLs included in the search results, such that, when the user selects the link, the user device 102 sets a software app into a state specified by the access URL. The display data included in each user-selectable link may indicate the state of the software app associated with the link and/or the app itself (e.g., describe the state and/or the app textually and/or graphically). Example user-selectable links are illustrated in FIGS. 7A-7J.

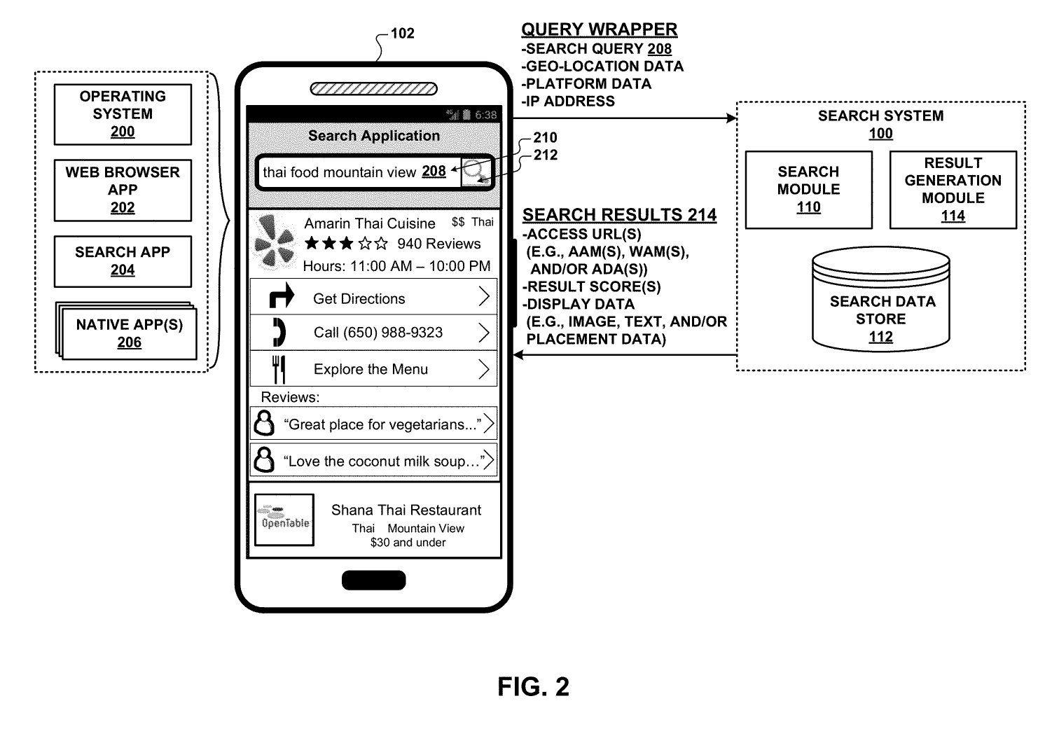

The user device(s) 102 may be any computing devices capable of providing search queries to the search system 100 and receiving search results from the system 100. The user device(s) 102 may include any of smartphones, and tablet, laptop, and desktop computing devices. The user device(s) 102 may also include any computing devices having other form factors, such as those included in vehicles, gaming devices, televisions, or other appliances (e.g., networked home automation devices and home appliances). The user device(s) 102 may use a variety of different operating systems or platforms (e.g., an OS 200, as shown in FIG. 2). For example, in the event that the user device 102 is a mobile device, the device 102 may operate using an OS such as ANDROID® by Google Inc., IOS® by Apple Inc., or WINDOWS PHONE® by Microsoft Corporation. Alternatively, in the event that the user device 102 is a laptop or desktop computing device, the device 102 may operate using an OS such as MICROSOFT WINDOWS® by Microsoft Corporation, MAC OS® by Apple Inc., or LINUX® (LINUX is the registered trademark of Linus Torvalds in the U.S. and other countries). In general, the user device(s) 102 may interact with the search system 100 using operating systems other than those described herein, whether presently available or developed in the future.

The user device(s) 102 may communicate with the search system 100 via the network 106. In general, the user device(s) 102 may communicate with the search system 100 using any app that can transmit search queries to the system 100 and receive search results from the system 100. In some examples, the user device(s) 102 may include an app that is dedicated to interfacing with the search system 100, such as an app dedicated to search (e.g., a search app 204, as further shown in FIG. 2). In other examples, the user device(s) 102 may communicate with the search system 100 using a more general app, such as a web browser app (e.g., a web browser app 202, as also shown in FIG. 2). An app included on a user device 102 to communicate with the search system 100 may display a graphical user interface (GUI) including a search field, bar, or box into which a user may enter search queries. For example, the user may enter the search queries using a touchscreen, a physical keyboard, a speech-to-text program, or another form of user input available on the user device 102. The app may be configured to transmit the search queries to the search system 100 (e.g., in response to additional user inputs).

In some examples, the user device 102 may use the same dedicated or more general app to display the search results received from the search system 100 to the user. For example, the user device 102 may display the search results via the GUI used to receive the search queries from the user and transmit the queries to the search system 100, as described herein. The GUI may display the search results to the user in a variety of different ways, depending on the information transmitted by the search system 100 to the user device 102 as part of the results. As previously described, the search results may include one or more access URLs, such as AAMs and/or WAMs, as well as display data, result scores, and/or other information used to generate user-selectable links for the access URLs. The GUI may display the search results to the user as a list of the user-selectable links, including text and/or image data. For example, the text and/or image data may describe and/or depict the states of the native or web-based apps specified by the access URLs (e.g., using alphanumeric strings, state “screenshots,” and/or app “icons”). In some examples, the GUI may display the search results as the list of the user-selectable links arranged under the search field into which the user has entered a search query. For example, the GUI may arrange the user-selectable links by result scores associated with the links, e.g., with the access URLs for which the links are generated, or using other logic. The GUI may also group the user-selectable links by the corresponding software apps (e.g., using app headers).

The data source(s) 104 may be any sources of data that the search system 100 may use to generate and/or update the search data store 112. The search system 100 may use the data source(s) 104 to generate and/or update one or more databases, indices, tables, files, or other data structures, such as state records, included in the search data store 112. As a specific example, the search system 100 may generate new state records and/or update existing state records based on data retrieved from the data source(s) 104. For instance, the search system 100 may include one or more modules (not shown) that generate new state records and/or update existing state records based on the data. In some examples, some or all of the data included in the search data store 112, such as one or more state records, may be manually generated by a human operator.

The data source(s) 104 may include a variety of different data providers. For example, the data source(s) 104 may include data from app developers, such as app developer websites and data feeds provided by app developers. The data source(s) 104 may also include operators of digital distribution platforms configured to distribute apps to user devices. The data source(s) 104 may further include other websites, such as websites that include web logs, or blogs, app reviews, or other data related to apps. Additionally, the data source(s) 104 may include social networking sites, such as “FACEBOOK®” by Facebook Inc., including Facebook posts, and “TWITTER®” by Twitter Inc., including text from tweets. The data source(s) 104 may also include other types of data sources, which may have various types of content and update rates. In some examples, the search system 100 may retrieve data from the data source(s) 104, including any type of data related to apps and/or app functionality. The search system 100 may then generate one or more state records based on the data and store the records in the search data store 112. In other examples, some or all of the data, such as SI, included in the state records of the search data store 112 may be manually generated by a human operator. In further examples, the data included in the state records may be periodically updated over time such that the search system 100 is able to provide up-to-date, or current, search results in response to receiving search queries specified by users of the user device(s) 102 from the device(s) 102.

FIG. 2 illustrates an example of one of the user device(s) 102 in communication with the search system 100. Specifically, FIG. 2 depicts example interactions and data exchanged among the user device 102 and the search system 100. As shown in FIG. 2, the user device 102 may transmit a query wrapper to the search system 100. The query wrapper may include a search query 208, geo-location data, platform data, and/or other information associated with the user, the user device 102, and/or the query 208 (e.g., an IP address). For example, the user may have entered the search query 208 into a search field 210 of a GUI of a search app 204 included on the user device 102. In this example, the user may have subsequently caused the search app 204 to submit the search query 208 to the search system 100 as part of the query wrapper by selecting a search button 212 of the GUI (e.g., located adjacent to the search field 210).

Upon receiving the query wrapper from the user device 102, the search system 100 may generate one or more search results 214 using the search query 208. To generate the search results 214, the search system 100 may identify one or more state records included in the search data store 112 based on the search query 208. The search system 100 may further generate result scores for, or rank, the identified state records. The search system 100 may then select one or more of the identified and ranked state records based on the corresponding result scores and select one or more access URLs, including AAMs and/or WAMs, from each selected record. As described herein, each access URL may specify a state of a native or web-based app (e.g., in the event that the access URL is an AAM or a WAM, respectively). As also described herein, the state specified by each access URL may be associated with one or more functions, such as “make a restaurant reservation,” “read user reviews,” or “write a user review,” each of which is performed based on one or more parameters (e.g., an entity, a geographic location, or another parameter or parameter type) as part of the state. In some examples, the search system 100 may also select one or more ADMs, each of which may be associated with an AAM, from the selected state records. The search system 100 may then transmit the search results 214 to the user device 102. In this example, each search result 214 may include the one or more access URLs associated with one of the selected state records. Each search result 214 may further include one or more ADMs, display data, result scores, and/or other information that is selected from, associated with, and/or generated for the corresponding one of the selected state records.

In the example of FIG. 2, upon receiving the search results 214 from the search system 100, the user device 102 may display the results 214 to the user as one or more user-selectable links. For example, for a first one of the search results 214, the user device 102 may display a first user-selectable link that includes a first access URL included in the result 214. As described herein, the first access URL may specify a first state of a native or web-based app. For example, the first access URL may specify a screen of a particular one of one or more native apps 206 that are included on the user device 102, or a web page that is accessible via a web browser app 202 also included on the device 102. As also described herein, the first state may be associated with a function that is performed based on a first parameter. The first user-selectable link may be configured to, upon being selected, such as touched, pressed, or clicked on, by a user input, cause the user device 102 to set the native or web-based app into the first state.

In some examples, the first search result 214 may also include one or more ADMs that each indicate a location from which a native app referenced by an AAM also included in the result 214 may be downloaded. In these examples, the user device 102 may generate the first user-selectable link to include some or all of the ADMs and the corresponding AAMs included in the first search result 214. As a result, in cases where the first access URL is an AAM, the user device 102 may be configured to, upon the user selecting the first user-selectable link, first download a native app referenced by the URL from a location specified by a corresponding ADM also included in the link and install the app on the device 102. The user device 102 may be further configured to, upon downloading and installing the native app, launch the app and set the app into the first state in a similar manner as previously described.

In the example of FIG. 2, the user device 102 may further receive a first user input from the user and, in response to receiving the input, display a second, different user-selectable link associated with a second, different search result 214. The second search result 214 may specify a second, different parameter. As described herein, in some examples, the user device 102 may have previously received the second search result 214 from the search system 100, displayed the result 214 as the second user-selectable link to the user, and stored the result 214 and/or the link in a local or remote storage location upon receiving another user input from the user. In these examples, to display the second user-selectable link in response to receiving the first user input, the user device 102 may first retrieve the second search result 214 and/or the link from the local or remote storage location. For example, the first user input may include one or more user interactions with a user menu displayed at the user device 102, where the interactions are configured to retrieve the second search result 214 and/or the second user-selectable link from the local or remote storage location and display the link, as also described herein.

The user device 102 may also receive a second, different user input from the user. The second user input may select the first and second user-selectable links. In some examples, the second user input may select the second user-selectable link, drag the link toward the first user-selectable link, and drop the second user-selectable link onto the first user-selectable link. In other examples, the second user input may substantially simultaneously select the first and second user-selectable links. Alternatively, the second user input may include one or more user interactions with a user menu displayed at the user device 102, where the interactions are configured to select the first and second user-selectable links. In response to receiving the second user input, the user device 102 may display a third, different user-selectable link associated with the first and second search results 214. Specifically, the third user-selectable link may be configured to, upon being selected, such as touched, pressed, or clicked on, by a user input, cause the user device 102 to set the native or web-based app associated with the first search result 214 into a second, different state specified by a second, different access URL (e.g., a different screen or web page specified by a different AAM or WAM, respectively). In particular, the second state may be associated with the same function as that of the first search result 214. However, in the example of FIG. 2, the function associated with the second state may be performed based on the second parameter specified by the second search result 214.

In some examples, the user device 102 may generate the first and second user-selectable links using display data included in the first and second search results 214, respectively. For example, the display data may include text describing a name of a corresponding software app and/or its state. Additionally, or alternatively, the display data may include image data corresponding to an icon, or a screenshot, associated with the software app and/or its state. In this manner, the display data included in and used to generate each of the first and second user-selectable links may describe the corresponding software app and/or the state of the app associated with the link. In some examples, the user device 102 may generate the third user-selectable link by combining some or all of the display data included in the first and second search results 214. Alternatively, the user device 102 may generate the third user-selectable link using display data included in a third, different search result 214 received from the search system 100 in response to the device 102 transmitting to the system 100 a version of the search query 208 that has been modified based on the first access URL and/or the second parameter.

In additional examples, the user device 102 may further arrange the first, second, and/or third user-selectable links as part of displaying the links to the user based on one or more result scores that are associated with the links (e.g., order, or rank, the links). As one example, the user device 102 may assign the first user-selectable link the result score associated with the state record from which the first access URL included in the link was selected. Similarly, the user device 102 may assign the second user-selectable link a result score associated with a state record from which an access URL included in that link was selected. Alternatively, the user device 102 may assign the second user-selectable link a result score that is associated with another data structure used to generate the second search result 214 and ultimately the link (e.g., a record specifying a native app, a web page, a document, and/or a media file). As still another example, the user device 102 may generate the result score for the third user-selectable link based on the result scores associated with the first and second user-selectable links (e.g., by aggregating, averaging, or otherwise combining the scores). Alternatively, the user device 102 may receive the result score for the third user-selectable link as part of the third search result 214 previously described. The user device 102 may then arrange the first, second, and/or third user-selectable links based on the corresponding result scores (e.g., display higher-ranking ones of the links higher within a list). Example search results 214 displayed to a user of a user device 102 as first, second, and third user-selectable links are described with reference to FIGS. 7A-7J.

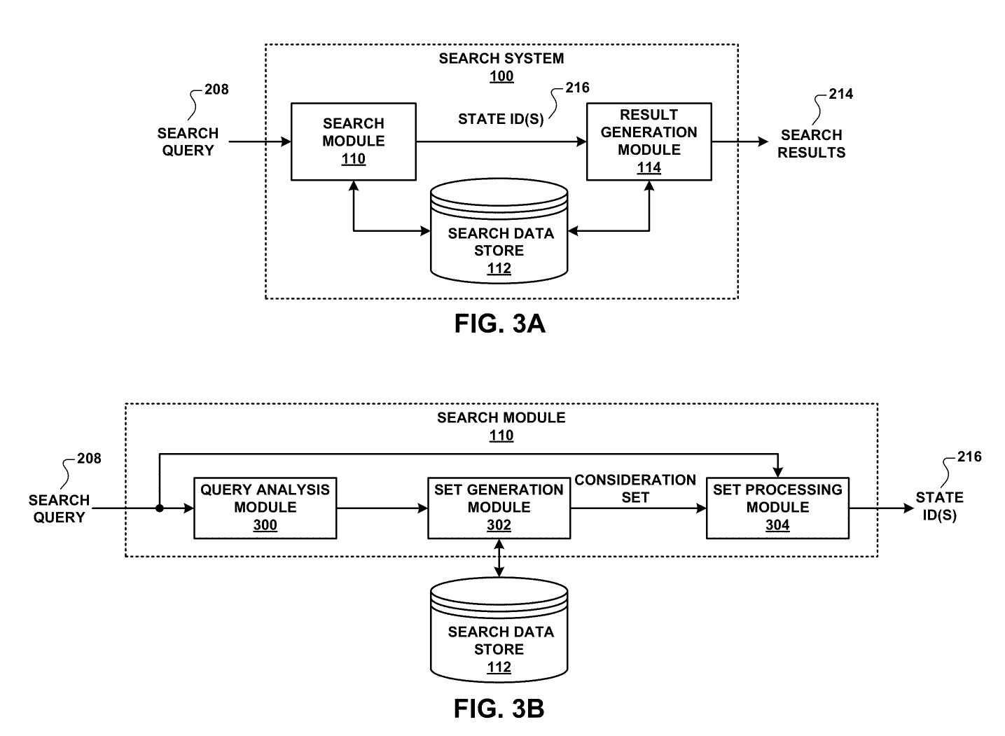

FIG. 3A illustrates an example search system 100. As described herein, the search system 100 generates one or more search results 214 using a search query 208 received from one of the user device(s) 102 and data included in one or more state records of the search data store 112. Specifically, the search module 110 identifies one or more state records included in the search data store 112 based on the search query 208. In some examples, the search module 110 further ranks the identified state records. For example, the search module 110 may generate result scores for the identified state records. The search module 110 then transmits one or more state IDs 216 that indicate the identified and, in some examples, ranked state records to the result generation module 114. The result generation module 114 receives the state IDs 216 from the search module 110, identifies the corresponding state records in the search data store 112 using the IDs 216, and selects one or more access URLs from the records. The result generation module 114 then transmits the selected access URLs to the user device 102 as the search results 214. In some examples, the result generation module 114 may transmit additional information selected from, associated with, and/or generated for the identified state records to the user device 102 as part of the search results 214, such as display data, result scores, and other information.

FIG. 3B is a functional block diagram of an example search module 110. FIG. 3B also depicts an example search data store 112. The search module 110 of FIG. 3B includes a query analysis module 300, a consideration set generation module (hereinafter, “set generation module”) 302, and a consideration set processing module (hereinafter, “set processing module”) 304. The query analysis module 300 receives a search query 208 from one of the user device(s) 102 (e.g., as part of a query wrapper). Upon receiving the search query 208, the query analysis module 300 analyzes the query 208. For example, the query analysis module 300 may perform any of tokenization, filtering, stemming, synonymization, and stop word removal with respect to the search query 208. The set generation module 302 identifies one or more state records included in the search data store 112 based on the analyzed search query 208. For example, the set generation module 302 may identify the state records based on one or more text matches between one or more terms of the analyzed search query 208 and one or more terms of information included in, associated with, and/or generated for the records (e.g., SI and/or state IDs). In a specific example, the set generation module 302 may identify the state records using the analyzed search query 208 as an input to Lucene® information retrieval software developed by Apache Foundation. The identified state records may be referred to herein as a “consideration set.” The set processing module 304 processes the consideration set (e.g., scores and selects a subset of the set). For example, the set processing module 304 may generate a result score for each state record included in the consideration set, thereby ranking the records, and select one or more records from the set having the largest one or more result scores. The set processing module 304 then transmits one or more state IDs 216 associated with the state records of the consideration set to the result generation module 114, as described herein. For example, the set processing module 304 may transmit one or more state IDs 216 included in the state records selected by the module 304 from the consideration set based on the corresponding result scores.

The information conveyed by the search results 214 may depend on the manner in which the set processing module 304 generates the result scores for the state records included in the consideration set. For example, for each state record, the corresponding result score may be generated based on various features associated with the record, such as relevance of the state of the software app specified by the record to the search query 208, popularity of the state, and/or other properties of the state, depending on the one or more parameters the set processing module 304 uses to score the record. The set processing module 304 may generate the result scores for the state records of the consideration set in a variety of different ways. In some examples, the set processing module 304 generates a result score for a particular one of the state records based on one or more scoring features. The scoring features may be associated with the state record, the search query 208, and/or other information. A state record scoring feature (hereinafter, “record scoring feature”) may be based on any data associated with a state record. For example, a record scoring feature may be based on any data included in SI of a state record. An example record scoring feature may be a popularity score associated with a state record (e.g., generated based on user ratings of the corresponding software app or its state). A query scoring feature may include any data associated with a search query 208. For example, a query scoring feature may include any of a number of words in a search query 208, popularity of the query 208, and an expected frequency of the words in the query 208. A record-query scoring feature may include any data generated based on information associated with both a state record and a search query 208 that resulted in identification of the record by the set generation module 302. For example, a record-query scoring feature may include any parameters that indicate how well terms of a search query 208 match terms of SI and/or a state ID of a state record identified using the query 208. The set processing module 302 may generate a result score for a state record using any of the record, query, and record-query scoring features, and/or any other scoring feature not explicitly listed.

In some examples, to generate the result scores for the state records included in the consideration set, the set processing module 304 may use one or more machine-learned models configured to receive one or more of the record, query, and record-query scoring features (e.g., a supervised learning model, in some examples including regression). For example, the set processing module 304 may pair the search query 208 with each state record of the consideration set and calculate a vector of features for each (query, record) pair. The vector of features may include one or more of the record, query, and record-query scoring features. The set processing module 304 may then input the vector of features into a machine-learned relevance (MLR) model to calculate a result score for the corresponding state record (e.g., simultaneously based on the features). In some examples, the MLR model may include a set of decision trees (e.g., gradient-boosted decision trees). In other examples, the MLR model may be trained by a simple form of logistic regression. In still other examples, the machine-learned task described herein may be framed as a semi-supervised learning task, where a minority of training data is labeled with human-curated result scores and the rest of the data is used without such labels.

The result scores generated by the set processing module 304 for the state records included in the consideration set may be used in various different ways. In some examples, the result scores may be used to rank, or order, the access URLs included in the corresponding state records within a list. In these examples, a larger result score may indicate that the associated access URL specifying a particular state of a software app is more relevant to the search query 208, or to the user, than another access URL specifying a different state of a software app and associated with a smaller result score. In examples where the search results 214 are displayed as a list of multiple user-selectable links, those of the links including access URLs associated with larger result scores may be displayed closer to the top of the list (e.g., near the top of the screen). In these examples, the user-selectable links including access URLs having lower result scores may be displayed farther down the list, or off-screen, and accessed by scrolling down the screen.

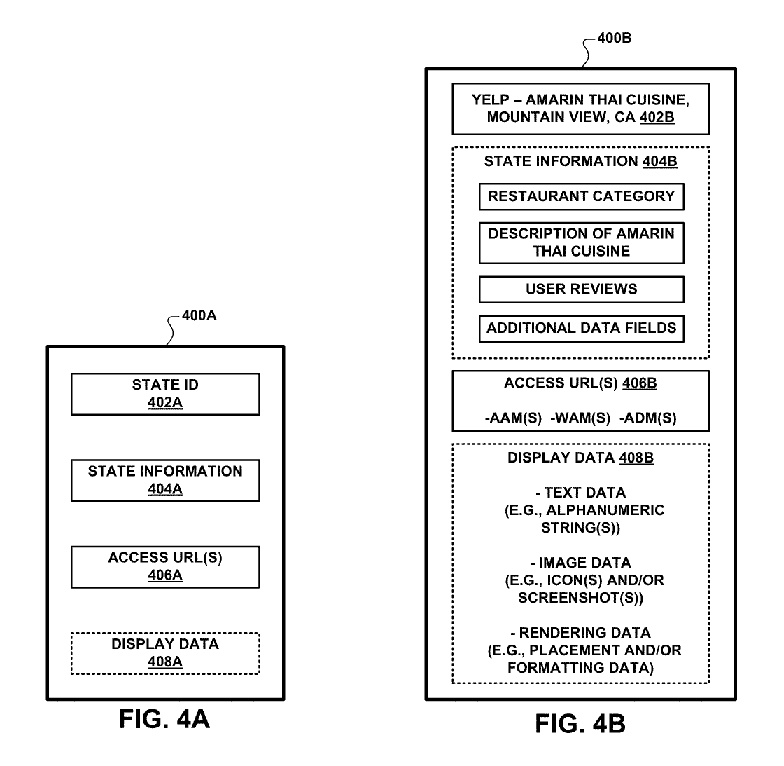

FIGS. 4A-4B illustrate example state records 400A, 400B that may be included in the search data store 112. FIG. 4A illustrates a general example of a state record 400A. The state record 400A of FIG. 4A includes information that specifies a state of a native or web-based app. As shown in FIG. 4A, the state record 400A includes a state ID 402A that uniquely identifies the record 400A among other state records included in the search data store 112. As also shown, the state record 400A includes SI 404A, which may include text, that describes the state specified by the record 400A and may be used to identify the record 400A in the search data store 112. As further shown, the state record 400A includes one or more access URLs 406A, which may include AAMs and/or WAMs, that enable a user device 102 to access the state specified by the record 400A in the native or web-based app. As one example, the access URL(s) 406A may include an AAM that references a native app and indicates one or more operations for the app, or a user device 102, to perform. The native app performing the operations may set the app into the state specified by the state record 400A. In response to a user selecting a user-selectable link that includes the AAM on a user device 102, the device 102 may launch the native app and set the app into the state using the AAM. In some examples, the access URL(s) 406 may include the AAM and an ADM. The ADM may specify a location, such as a digital distribution platform, where a user device 102 may download the native app referenced by the AAM (e.g., Google Play® by Google Inc.). In response to a user selecting a user-selectable link that includes the ADM on a user device 102, the device 102 may download the native app using the ADM and install the app. The user device 102 may then launch the native app and set the app into the state specified by the state record 400A using the AAM also included in the user-selectable link. In other examples, the access URL(s) 406A may include a WAM that references a web-based app and indicates one or more operations for the app, or a user device 102, to perform. The web-based app performing the operations may set the app into the state specified by the state record 400A. For example, the WAM may specify a state of the web-based app that is equivalent or analogous to the state of the native app specified by the AAM. In response to a user selecting a user-selectable link that includes the WAM on a user device 102, the device 102 may launch the web browser app 202 included on the device 102 and access the state using the WAM. In some examples, the WAM may include a resource ID that references a web resource (e.g., a particular page of the web-based app). For instance, the WAM may include a URL, such as a web address, used with HTTP. In these examples, upon the user selecting the user-selectable link including the WAM, the user device 102 may launch the web browser app 202 and retrieve the web resource referenced by the resource ID (e.g., access the page of the web-based app). As also shown, the state record 400A may include display data 408A. The display data 408A may include text describing the state of the native or web-based app specified by the state record 400A and/or the app itself. Additionally, or alternatively, the display data 408A may include image data, such as one or more icons or screenshots, associated with the state and/or the app.

In additional examples, the state record 400A may include information describing values of one or more metrics associated with a person, place, or thing described in the record 400A. Example metrics include popularity and/or user ratings of the place. For example, if the state record 400A describes a song, a metric associated with the song may be based on popularity and/or user ratings of the song. The information included in the state record 400A may also be based on measurements associated with the record 400A, such as how often the record 400A is retrieved during a search and how often user-selectable links generated for any of the access URL(s) 406A are selected by a user. The information may also indicate whether the state record 400A includes an AAM for a default state, or a deeper state, of a native app. In some examples, the search system 100, namely the set processing module 304, may use this information to generate a result score for the state record 400A, as described herein (e.g., upon identifying the record 400A and as part of ranking the record 400A among other identified state records).

FIG. 4B illustrates a specific example of a state record 400B that specifies a state of a native or web-based app “YELP®” by Yelp Inc. (hereinafter, “Yelp”). The state specified by the state record 400B corresponds to an entry in, such as a web page or a screen of, Yelp for the restaurant “Amarin Thai Cuisine” located in Mountain View, Calif. As shown in FIG. 4B, the state record 400B includes a state ID “Yelp—Amarin Thai Cuisine, Mountain View, Calif.” 402B that uniquely identifies the record 400B among other state records included in the search data store 112. In other examples, the state ID 402B may be a numeric value, or have another representation (e.g., a machine-readable representation). As further shown, the state record 400B includes SI 404B that describes the state specified by the record 400B. The SI 404B describes a restaurant category, a description, user reviews, and/or any other information related to the Amarin Thai Cuisine restaurant associated with the state specified by the state record 400B. In some examples, the SI 404B may also describe one or more functions provided by the state, such as, e.g., “make a restaurant reservation,” “read user reviews,” and “write a user review.” As still further shown, the state record 400B includes one or more access URLs 406B, such as one or more AAMs, WAMs, and/or ADMs, that enable a user device 102 to access the state specified by the record 400B in Yelp. As a specific example, the access URL(s) 406B may include an alphanumeric string “HTTP://WWW.YELP.COM/BIZ/AMARIN-THAI-CUISINE-MOUNTAIN-VIEW.” As also shown, the state record 400B includes display data 408B. The display data 408B includes any of text data, such as one or more alphanumeric strings, image data, such as one or more icons and/or screenshots, and rendering data, such as placement and/or formatting data, associated with the entry in Yelp for the Amarin Thai Cuisine restaurant.

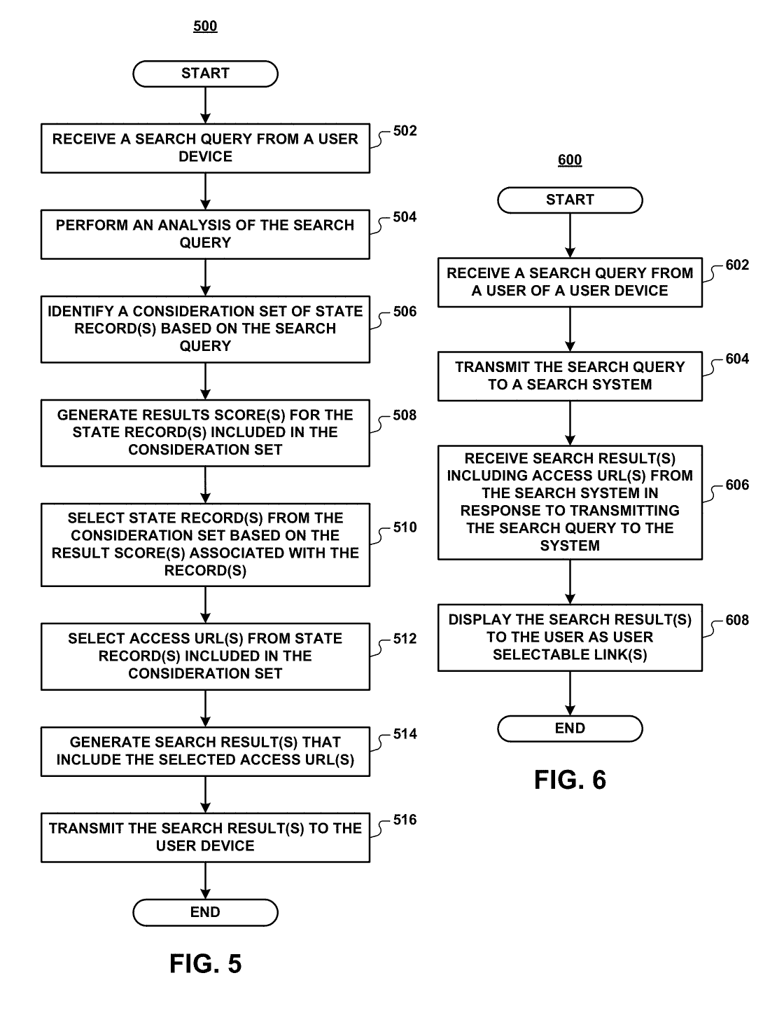

FIG. 5 is a flow diagram that illustrates an example method 500 for generating search results 214 based on a search query 208 using the search system 100. As shown in FIG. 5, in block 502, the search system 100 may initially receive a search query 208 specified by a user from one of the user device(s) 102 (e.g., as part of a query wrapper). In block 504, the search system 100 may optionally perform an analysis of the search query 208. For example, the query analysis module 300 may perform any of tokenization, filtering, stemming, synonymization, and stop word removal with respect to the search query 208. In some examples, the search system 100 may receive additional information from the user device 102 (e.g., as part of the query wrapper, or separately from the wrapper). For example, the additional information may include information associated with the user, information associated with the search query 208, and/or geo-location, platform, and IP address information associated with the user device 102.

In block 506, the set generation module 302 may identify a consideration set of one or more state records included in the search data store 112 based on the search query 208 (e.g., based on the analyzed search query 208). As described herein, each identified state record of the consideration set may include an access URL that specifies a state of a software app, such as a native or web-based app, and SI, such as text, that describes the state. As also described herein, the state may be associated with one or more functions, such as “write a user review,” that may be performed based on one or more parameters, such as an entity (e.g., a business).

In blocks 508-510, the set processing module 304 may optionally process the consideration set of state records. Specifically, in block 508, the set processing module 304 may generate one or more result scores for the state records included in the consideration set (e.g., generate a result score for each record). In block 510, the set processing module 304 may select one or more state records from the consideration set based on the one or more result scores associated with the records (e.g., select a subset of the records included in the set). For example, the set processing module 304 may select one or more state records included in the consideration set that are associated with the largest one or more result scores.

In block 512, the result generation module 114 may select one or more access URLs from the state records included in the consideration set. For example, the result generation module 114 may select the access URLs from the state records that the set processing module 304 selects from the consideration set based on the corresponding result scores (e.g., select one access URL from each selected record). In some examples, the result generation module 114 may select additional information included in, associated with, and/or generated for the state records of the consideration set, such as display data, result scores, and/or other information.

In block 514, the result generation module 114 may generate one or more search results 214 that include the selected access URLs. For example, the result generation module 114 may generate the search results 214 such that each result 214 includes one of the access URLs and, optionally, other information included in, associated with, and/or generated for the corresponding state record. In block 516, the result generation module 114 may transmit the search results 214, including the access URLs and any other information, to the user device 102.

FIG. 6 is a flow diagram that illustrates an example method 600 for generating search results 214 based on a search query 208 using one of the user device(s) 102. As shown in FIG. 6, in block 602, one of the user device(s) 102 may initially receive a search query 208 from a user of the device 102. As described herein, the user device 102 may receive the search query 208 from the user via a search app 204 executing on the device 102. In block 604, the user device 102 may transmit the search query 208 to the search system 100. As also described herein, the user device 102 may transmit the search query 208 to the search system 100 in response to receiving an input from the user via the search app 204. In this example, the search system 100 may receive the search query 208 from the user device 102 and generate one or more search results 214 using the query 208. The search results 214 may include one or more access URLs, such as AAMs, WAMs, and/or ADMs, display data, result scores, and/or other information. The search system 100 may transmit the search results 214 to the user device 102. Accordingly, in block 606, the user device 102 may receive the search results 214, including the access URLs, from the search system 100 in response to transmitting the search query 208 to the system 100. In block 608, the user device 102 may display the access URLs to the user as one or more user-selectable links. As described herein, the user device 102 may display the access URLs as the user-selectable links using the search app 204. For example, the user device 102 may generate each user-selectable link to include one or more of the access URLs and, e.g., the corresponding display data and/or other information also received as part of the search results 214. In some examples, the user device 102 may further rank, or arrange within an order, the user-selectable links including the access URLs based on the corresponding result scores also received along with the search results 214. In some examples, the user device 102 may display the user-selectable links as one or more so-called “cards” that include the links and various other information, such as text, image, and/or rendering data, enclosed in a visual boundary.

FIGS. 7A-7J illustrate example GUIs that may be generated on one of the user device(s) 102 according to this disclosure. The examples of FIGS. 7A-7J depict the user device 102 performing searches for states of software apps using search queries 208 specified by a user of the device 102. FIGS. 7A-7J also depict the user device 102 combining multiple search results 214 generated as part of the searches in response to receiving user inputs from the user. As shown in FIGS. 7A-7J, the user may initially enter a search query 208 into a search field 210 of a GUI of a search app 204 executing on the user device 102. As also shown, the user may then interact with a search button 212 of the GUI to cause the search app 204 to transmit the search query 208 to the search system 100. The search system 100 may receive the search query 208 from the user device 102 and generate one or more search results 214 that specify states of software apps based on the query 208. Specifically, as described herein, each search result 214 may include an access URL, such as an AAM or a WAM, that specifies a state of a software app, such as a native or web-based app. As further described herein, in some examples, each of one or more of the search results 214 may also include an ADM associated with an AAM included in the result 214. As also described herein, the state specified by the access URL may be associated with one or more functions each of which may be performed based on one or more parameters. In particular, to generate the search results 214, the search system 100 may initially identify one or more state records included in the search data store 112 based on the search query 208. In some examples, the search system 100 may further rank the identified state records. The search system 100 may then select one or more access URLs from the identified and, in some examples, ranked state records. The search system 100 may subsequently transmit the search results 214, including the selected access URLs, to the user device 102. The user device 102 may receive the search results 214 from the search system 100 in response to transmitting the search query 208 to the system 100 and display the results 214 to the user as one or more user-selectable links.

With reference to FIG. 7E, the user device 102, namely the search app 204, may display a first one of the search results 214 to the user as a first user-selectable link 700-3 within a GUI. For example, the user device 102 may generate the first user-selectable link 700-3 using display data, such as text and/or image data, received from the search system 100 as part of the first search result 214. As described herein, the first search result 214 may include a first access URL that specifies a first state of a software app. As also described herein, the first state may be associated with a function that is performed based on a first parameter. Specifically, as shown in FIG. 7E, the first state corresponds to a state of a native app Uber® by Uber Inc. (hereinafter, “Uber”). As also shown, the state of Uber associated with FIG. 7E is configured to enable a user to order an Uber car to transport the user from the user's current location to a destination location that may be specified by the user. In other words, in the example of FIG. 7E, the first state of the software app Uber specified by the first access URL included in the first search result 214 may be associated with the function “get a ride to” that may be performed based on the first parameter corresponding to the destination location (e.g., a particular geographic location).

In the example of FIG. 7E, the first search result 214 does not specify the first parameter, namely the destination location. In other examples, the first search result 214 may specify the first parameter. For example, the first search result 214 may specify the first parameter in cases where the search query 208 specifies the destination location (e.g., the query 208 includes the string “Uber to [destination location]” that specifies the location). In such instances, the first access URL may include the first parameter. Additionally, or alternatively, the user may specify the first parameter by providing a user input to the user device 102 after the device 102 displays the first user-selectable link 700-3 to the user. In further examples, the function “get a ride to” associated with the first state may also be performed based one or more additional parameters (e.g., a parameter corresponding to the user's current geographic location). In some examples, one or more of the additional parameters may not be specified. In other examples, one or more of the additional parameters may be specified by the first search result 214, for example, using information included in the first access URL and/or via one or more user inputs provided by the user to the user device 102, in a similar manner as previously described.

In the example of FIG. 7E, the first user-selectable link 700-3 may be configured to, upon being selected by a user input, cause the user device 102 to set the software app, namely Uber, into the first state (not shown). As shown in FIG. 7E, the user device 102 may display the first user-selectable link 700-3 in the form of a card that includes the link 700-3 and other information within a visual boundary. In some examples, the other information included in the card may correspond to one or more additional access URLs, such as one or more additional user-selectable links generated based on the access URLs, and/or other content, such as display data, received from the search system 100 as part of the first search result 214.

As shown in FIG. 7E, after displaying the first user-selectable link 700-3 to the user, the user device 102 may receive a first user input 718 from the user. As shown in FIGS. 7E-7G, the first user input 718 may be configured to cause the user device 102, namely the search app 204, to display a user menu that enables the user to retrieve previously stored search results 214. For example, as shown in FIG. 7E, the first user input 718 may select a GUI element 716 that invokes the user menu. As shown in FIG. 7F, the user menu may include user-selectable links 720-1 . . . 720-4 one of which, namely the link 720-1, upon being selected, may enable the user to retrieve the previously stored search results 214. As also shown, after displaying the user menu to the user, the user device 102 may receive another user input 722 from the user selecting the user-selectable link 720-1. As shown in FIG. 7G, in response to receiving the user input 722, the user device 102, namely the search app 204, may display a second, different user-selectable link 700-1 associated with a second, different search result 214 to the user. As described with reference to FIGS. 7A-7D, the user device 102 may have previously received the second search result 214 from the search system 100, displayed the result 214 to the user as the second user-selectable link 700-1, and stored the result 214 and/or the link 700-1 upon receiving a user input from the user. In this example, the second search result 214 may specify a second, different parameter, namely a geographic location associated with a particular Amarin Thai Cuisine restaurant located in Mountain View, Calif. For example, the user device 102 may generate the second user-selectable link 700-1 using display data, such as text and/or image data, previously received from the search system 100 as part of the second search result 214. As shown in FIG. 7G, the second search result 214 and the second user-selectable link 700-1 may be associated with a state of a native or web-based version of Yelp corresponding to an entry for the Amarin Thai Cuisine restaurant. In other examples, the second search result 214 and the second user-selectable link 700-1 may be associated with other content that specifies the geographic location associated with the restaurant (e.g., a native app, a web page, a document, and/or a media file). As shown in FIG. 7G, the user device 102 may display the second user-selectable link 700-1 in the form of a card that includes the link 700-1 and other information within a visual boundary.

As further shown in FIG. 7G, after displaying the second user-selectable link 700-1 to the user, the user device 102 may receive a second, different user input 724 from the user. As shown in FIGS. 7G-7H, the second user input 724, for example in conjunction with one or more additional user inputs, may be configured to select the first and second user-selectable links 700-3, 700-1. As shown in FIG. 7I, in response to receiving the second user input 724 and any additional user inputs, the user device 102, namely the search app 204, may be configured to combine the first and second user-selectable links 700-3, 700-1 and generate a third, different user-selectable link 700-4 associated with the first and second search results 214. For example, as shown in FIG. 7G, the second user input 724 may select the second user-selectable link 700-1. As shown in FIG. 7H, upon the second user input 724 selecting the second user-selectable link 700-1, user device 102, namely the search app 204, may display a minimized version 704, such as an icon, of the link 700-1 adjacent to the first user-selectable link 700-3. As also shown, upon displaying the minimized version 704 of the second user-selectable link 700-1, the user device 102 may receive an additional user input 726, which may be a continuation of the second user input 724, from the user selecting the minimized version 704. As further shown, the user input 726 may be configured to drag the minimized version 704 of the second user-selectable link 700-1 toward the first user-selectable link 700-3 along a trajectory 728 and drop the minimized version 704 onto the first user-selectable link 700-3. As a specific example, as shown in FIG. 7H, the user input 726 may be configured to drop the minimized version 704 of the second user-selectable link 700-1 substantially onto a portion of the first user-selectable link 700-3 associated with the first parameter, namely the destination location. As also shown, the portion may be highlighted (e.g., outlined using a bold line) to indicate that the minimized version 704 of the second user-selectable link 700-1 may be dropped onto the portion, as described herein. In some examples, in the event the minimized version 704 may not be dropped onto the portion, the portion may be grayed out, as also described herein. In other examples, the user input 726 may be configured to drop the minimized version 704 of the second user-selectable link 700-1 onto another portion of the first user-selectable link 700-3 (e.g., a portion associated with another parameter, such as the current location), or anywhere else within the link 700-3.

As shown in FIG. 7I, in response to receiving the second user input 724 and the additional user input 726, the user device 102, namely the search app 204, may display the third user-selectable link 700-4 to the user. In this example, the third user-selectable link 700-4 may be configured to, upon being selected by a user input, cause the user device 102 to set the software app associated with the first user-selectable link 700-3, namely Uber, into a second, different state specified by a second, different access URL. Also in this example, the second state may be associated with the same function as that of the first user-selectable link 700-3, namely “get a ride to.” However, in the second state, the function may be performed based on the second parameter, namely the geographic location associated with the Amarin Thai Cuisine restaurant. In particular, the state of Uber associated with FIG. 7I is configured to enable a user to order an Uber car to transport the user from the user's current location to the Amarin Thai Cuisine restaurant. In other words, in the example of FIG. 7I, the second state of the software app Uber specified by the second access URL may be associated with the function “get a ride to” that may be performed based on the second parameter corresponding to the geographic location associated with the restaurant that may be different from the original destination location.

In some examples, the user device 102 may generate the second access URL by inserting at least a portion of the second parameter into a field, or a parameter placeholder, of the first access URL configured to include the first parameter. As a specific example, the user device 102 may replace the first parameter in the first access URL with one or more terms associated with the second parameter. In other examples, the user device 102 may modify the search query 208 based on the first access URL and the second parameter, transmit the modified query 208 to the search system 100, and receive a third, different search result 214 from the system 100 that includes the second access URL. As a specific example, with reference to FIGS. 7A-7J, the user device 102 may modify the search query 208 including the string “Uber” to include the string “Uber to Amarin Thai Cuisine Mountain View Calif.” In these examples, the user device 102 may also receive one or more additional search results 214 that are responsive to the modified search query 208 and display the results 214 to the user as one or more additional user-selectable links (e.g., adjacent to the third user-selectable link 700-4). In still other examples, the user device 102 may generate the third user-selectable link 700-4 using display data, such as text and/or image data, received from the search system 100 as part of the first, second, and/or third search results 214. For example, the user device 102 may generate the third user-selectable link 700-4 by combining elements of the display data associated with the first and second search results 214 (e.g., portions of the data that apply to the third user-selectable link 700-4). Additionally, or alternatively, the user device 102 may generate the third user-selectable link 700-4 using the display data associated with the third search result 214 received from the search system 100 in response to the modified search query 208. In any case, as shown in FIG. 7I, the user device 102 may display the third user-selectable link 700-4 in the form of a card that includes the link 700-4 and various other information within a visual boundary.

As shown in FIG. 7I, after displaying the third user-selectable link 700-4 to the user, the user device 102 may receive another user input 730 from the user selecting the link 700-4. As shown in FIG. 7J, in response to receiving the user input 730, the user device 102 may launch Uber and set Uber into the second state. In particular, as also shown, the user device 102 may configure Uber to display a GUI 700-5 that corresponds to the second state. Upon the user device 102 setting Uber into the second state, the user may interact with the state (e.g., order an Uber car to transport the user from the user's current location to the Amarin Thai Cuisine restaurant). As described herein, in some examples, upon receiving the user input 730, the user device 102 may initially download and install Uber using an ADM included in the third user-selectable link 700-4 and subsequently launch Uber and set Uber into the second state.

In some examples, the user causing the user device 102 to display the second user-selectable link 700-1, as described herein, may indicate the user's dissatisfaction with the functionality offered by the first user-selectable link 700-3. In these examples, the user may perform another search for states of software apps by selecting the search query field 210 of the search app 204 and be automatically provided with search query autosuggestions that are biased against, or that exclude, terms that relate to the first user-selectable link 700-3. As a specific example, in the event the first user-selectable link 700-3 specifies a state of Uber for transporting the user from the user's current location to the Amarin Thai Cuisine restaurant, the user device 102 may provide an autosuggestion for a search query 208 “Uber” specified by the user that includes the string “Uber to CasCal Mountain View Calif.”

FIGS. 7A-7D illustrate example techniques for generating and storing the second search result 214 and/or the second user-selectable link 700-1 described with reference to FIGS. 7E-7J. As shown in FIG. 7A, upon receiving the second search result 214 from the search system 100 in response to transmitting a search query 208 to the system 100, the user device 102, namely the search app 204, may display the result 214 to the user as the second user-selectable link 700-1 within a GUI. For example, the user device 102 may generate the second user-selectable link 700-1 using display data, such as text and/or image data, received from the search system 100 as part of the second search result 214. As described herein, the second search result 214 may specify the second parameter, namely the geographic location associated with the Amarin Thai Cuisine restaurant. In particular, as also shown in FIG. 7A, the second search result 214 and the second user-selectable link 700-1 may be associated with a state of Yelp corresponding to an entry for the Amarin Thai Cuisine restaurant. As described herein, in other examples, the second search result 214 and the second user-selectable link 700-1 may correspond to other content that specifies the second parameter. As also shown, the user device 102 may display the second user-selectable link 700-1 in the form of a card that includes the link 700-1 and a variety of other information within a visual boundary. As further shown, in some examples, the user device 102, namely the search app 204, may also receive one or more additional search results 214 from the search system 100 and display the results 214 to the user as one or more user-selectable links within the same GUI (e.g., the user-selectable link 700-2).

As shown in FIG. 7A, after displaying the second user-selectable link 700-1 to the user, the user device 102 may receive a third, different user input 702 from the user. As shown in FIGS. 7A-7B, the third user input 702 may be configured to cause the user device 102, namely the search app 204, to display a user menu that enables the user to store the second search result 214 and/or the second user-selectable link 700-1. For example, as shown in FIG. 7A, the third user input 702 may select the second user-selectable link 700-1. As shown in FIG. 7B, upon the third user input 702 selecting the second user-selectable link 700-1, user device 102, namely the search app 204, may display the minimized version 704 of the link 700-1 and the user menu. As further shown, upon displaying the minimized version 704 of the second user-selectable link 700-1, the user device 102 may receive another user input 708 from the user selecting the minimized version 704. As also shown, the user input 708 may be configured to drag the minimized version 704 of the second user-selectable link 700-1 toward a user-selectable link 706-1 included in the user menu along a trajectory 710 and drop the minimized version 704 onto the link 706-1. As a result, the user device 102, namely the search app 204, may store the second search result 214 and/or the second user-selectable link 700-1 (e.g., in a local memory location and/or a remote data store). As further shown in FIG. 7B, the user menu may include one or more additional user-selectable links 706-2 . . . 706-3 that, upon being selected by a user input, may enable the user to retrieve recently viewed search results 214 or share search results 214 with other users (e.g., retrieve or share the corresponding user-selectable links). As also shown, the user menu may further include a user-selectable link 706-4 that, upon being selected, may enable the user to view and/or change various user settings associated with the search app 204.

FIG. 7C is analogous to FIG. 7A. With reference to FIG. 7D, upon the third user input 702 selecting the second user-selectable link 700-1, user device 102, namely the search app 204, may display a user menu that is similar to the user menu described with reference to FIGS. 7A-7B adjacent to the link 700-1. As shown in FIG. 7D, upon displaying the user menu, the user device 102 may receive another user input 714 from the user selecting a user-selectable link 712-1 included in the menu. As further shown, in response to receiving the user input 714, the user device 102, namely the search app 204, may store the second search result 214 and/or the second user-selectable link 700-1, in a similar manner as previously described. As also shown, the user menu may include one or more additional user-selectable links 712-2 . . . 712-4 that, upon being selected by a user input, may enable the user to retrieve recently viewed search results 214, share search results 214 with other users, or view and/or change various user settings associated with the search app 204, also in a similar manner as previously described.

In additional examples, to store a particular search result 214 and/or the corresponding user-selectable link, the user may perform a so-called “swipe” gesture with respect to the link, or with respect to a card that includes the link, in any direction relative to a screen of the user device 102. In other examples, the user may perform a gesture with respect to the screen, generally. In any case, in response to the user's gesture, the user device 102, namely the search app 204, may automatically store the search result 214 and/or the user-selectable link. Alternatively, in response to the user's gesture, the user device 102, namely the search app 204, may display the user menu described with reference to FIGS. 7A-7D that enables the user to store the search result 214 and/or the user-selectable link using one or more additional user inputs. In still other examples, the user may store the search result 214 and/or the user-selectable link using other techniques. In some examples, rather that receiving the search result 214 from the search system 100 and storing the result 214 and/or the user-selectable link, the user device 102 may receive the result 214 and/or the link as part of an advertisement directed to the user, or as a recommendation for the user from another user (e.g., via an e-mail or a text message).

In additional examples, the user device 102, namely the search app 204, may also rank multiple user-selectable links within a list (e.g., as shown in FIGS. 7A and 7C). For example, the user device 102 may order each user-selectable link based on a result score associated with a corresponding search result 214 (e.g., a result score received with the result 214 from the search system 100 or generated for the result 214, as described herein). In some examples (not shown), the user device 102 may further group multiple user-selectable links based on the corresponding software app (e.g., using an app header or another GUI element).

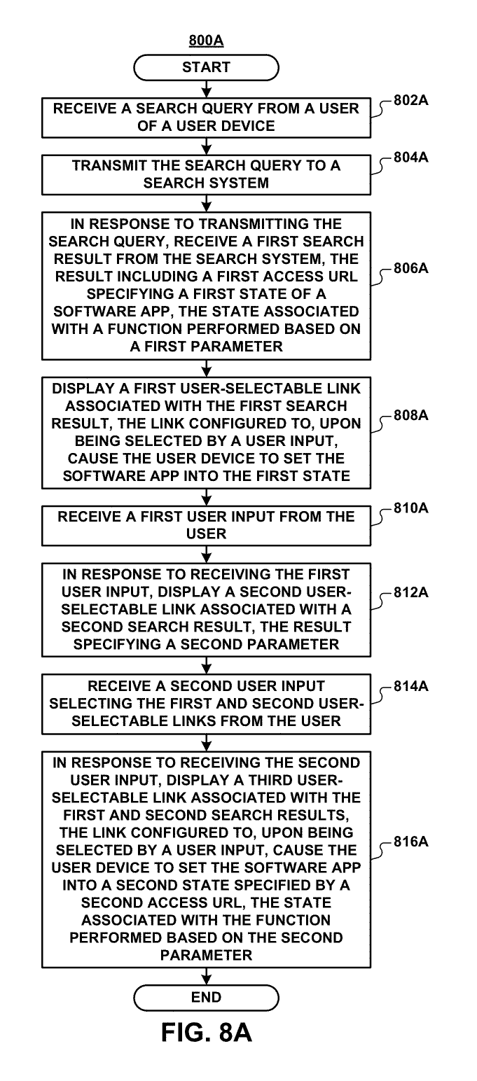

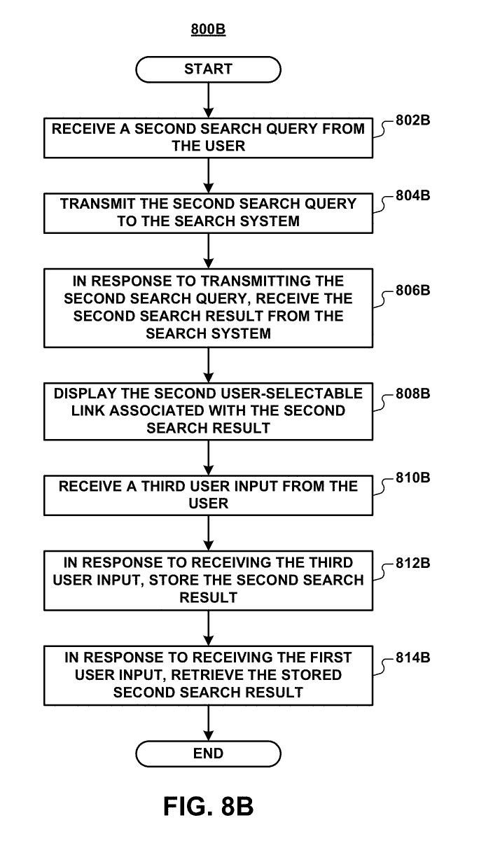

FIG. 8A is a flow diagram that illustrates an example method 800A for combining search results 214 that specify software app functions using one of the user device(s) 102. As shown in FIG. 8A, in block 802A, one of the user device(s) 102 may initially receive a search query 208 from a user of the device 102. As described herein, the user device 102 may receive the search query 208 from the user via a search app 204 executing on the device 102. In block 804A, the user device 102 may transmit the search query 208 to the search system 100. As also described herein, the user device 102 may transmit the search query 208 to the search system 100 in response to receiving an input from the user via the search app 204. In this example, the search system 100 may receive the search query 208 from the user device 102 and generate one or more search results 214 based on the query 208. As described herein, the search results 214 may include one or more access URLs, display data, result scores, and/or other information. The search system 100 may then transmit the search results 214 to the user device 102.

Accordingly, in block 806A, the user device 102 may receive a first one of the search results 214 from the search system 100 in response to transmitting the search query 208 to the system 100. In some examples, the user device 102 may also receive one or more additional ones of the search results 214 from the search system 100. As described herein, the first search result 214 may include a first access URL that specifies a first state of a software app (e.g., a native or web-based app). In this example, the first state may be associated with a function, such as “make a restaurant reservation,” “read user reviews,” and “write a user review,” that may be performed based on a first parameter. Also in this example, the first parameter may include an entity, such as a name of a specific business or a business franchise, a geographic location, a name of a product or service, or another parameter or parameter type. In some examples, the function associated with the first state may be performed based on one or more additional parameters. Furthermore, in other examples, the first state may be associated with one or more additional functions each of which may be performed based on one or more parameters. As also described herein, the first search result 214 may further include other information associated with the first access URL, such as display data, result scores, and/or other information.

In block 808A, the user device 102, namely the search app 204, may display a first user-selectable link associated with the first search result 214. As described herein, the first user-selectable link may be configured to, upon being selected by a user input, cause the user device 102 to set the software app into the first state. For example, the user device 102 may generate the first user-selectable link such that the link includes the first access URL and, e.g., the corresponding display data and/or other information received with the first search result 214 from the search system 100. The user device 102 may then display the first user-selectable link. In some examples, the user device 102 may also display one or more additional user-selectable links associated with one or more additional ones of the search results 214 received from the search system 100. In these examples, the user device 102 may further rank, or arrange in an order, the displayed user-selectable links, including the first user-selectable link, based on the corresponding result scores received with the search results 214. For example, the user device 102 may arrange the displayed user-selectable links in an order of decreasing result scores.

In block 810A, the user device 102, namely the search app 204, may receive a first user input from the user. In block 812A, in response to receiving the first user input, the user device 102, namely the search app 204, may display a second, different user-selectable link associated with a second, different search result 214. In this example, the second search result 214 may specify a second, different parameter, such as a different entity, a different geographic location, a name of a different product or service, or another parameter or parameter type. In some examples, the second search result 214 may also specify one or more additional parameters. For example, the user device 102 may retrieve the second search result 214 and/or the second user-selectable link from an internal memory location and/or a remote data store in response to receiving the first user input. As described with reference to FIG. 8B, the user may have previously received the second search result 214 from the search system 100 in response to transmitting a second, different search query 208 to the system 100, displayed the result 214 as the second user-selectable link, and, upon receiving a user input from the user, stored the result 214 and/or the link in the internal memory location or remote data store for later retrieval.

In block 814A, the user device 102, namely the search app 204, may receive a second, different user input selecting the first and second user-selectable links from the user. As described herein, in some examples, the second user input may select the first and second user-selectable links by selecting, such as touching, pressing, or clicking on, the second user-selectable link, dragging the link, and dropping the link onto the first user-selectable link. For example, the second user input may select the first and second user-selectable links using a so-called “two-finger” contact input that selects the second user-selectable link, drags the link, and drops the link onto the first user-selectable link also selected by the input. As also described herein, in other examples, the second user input may select the first and second user-selectable links by substantially simultaneously selecting, such as touching, pressing, or clicking on, the links. As further described herein, in still other examples, the second user input may include one or more user interactions by the user with a user menu displayed at the user device 102, namely within the search app 204. In these examples, the user interactions may be configured to select the first and second user-selectable links (e.g., by navigating the user through the user menu).

In block 816A, in response to receiving the second user input, the user device 102, namely the search app 204, may display a third, different user-selectable link associated with the first and second search results 214. As described herein, the third user-selectable link may be configured to, upon being selected by a user input, cause the user device 102 to set the software app associated with the first search result 214 into a second, different state specified by a second, different access URL. In this example, the second state may be associated with the same function that is associated with the first state, such as “make a restaurant reservation,” “read user reviews,” and “write a user review.” However, in the second state, this function may be performed based on the second parameter, such as the different entity, geographic location, product or service name, or other parameter or parameter type previously described. For example, the user device 102 may generate the third user-selectable link such that the link includes the second access URL and, e.g., the corresponding display data and/or other information received with the first search result 214 and/or the second search result 214 from the search system 100. The user device 102 may then display the third user-selectable link (e.g., adjacent to the first user-selectable link, or in place of the first user-selectable link).

As described herein, in some examples, the user device 102 may generate the second access URL using the first access URL and the second parameter. As one example, the user device 102 may insert the second parameter into the first access URL, such as in place of the first parameter, or into a placeholder field configured to include the first parameter, to generate the second access URL. As a specific example, the user device 102 may generate a second access URL “HTTP://WWW.YELP.COM/BIZ/AMARIN-THAI-CUISINE-MOUNTAIN-VIEW” by inserting one or more terms associated with a second parameter “Amarin Thai Cuisine Mountain View Calif.” into a first access URL “HTTP://WWW.YELP.COM/BIZ/POSH-BAGEL-SAN-JOSE” or “HTTP://WWW.YELP.COM/BIZ/H.” In this example, the user device 102 may insert the terms into the first access URL using one or more rules and/or guidelines (e.g., permitted terms and required formatting) specified by a developer of the software app (e.g., Yelp).

As another example, the user device 102 may generate the second access URL by transmitting a modified version of the search query 208 to the search system 100 and, in response to transmitting the modified version, receiving a search result 214 from the system 100 that includes the URL (e.g., by performing a so-called “re-querying” of the system 100). For example, the user device 102 may generate the modified version of the search query 208 by adding one or more terms to the query 208, removing one or more terms from the query 208, and/or rearranging one or more terms of the query 208 based on the first access URL and the second parameter. As a specific example, the user device 102 may generate a modified version of a search query 208 (e.g., “Uber”) by incorporating one or more terms associated with a first access URL (e.g., “Uber from current location to destination”) and/or a second parameter (e.g., “Amarin Thai Cuisine Mountain View Calif.”) into the query 208 (e.g., “Uber from current location to Amarin Thai Cuisine Mountain View Calif.,” or “Uber Amarin Thai Cuisine Mountain View Calif.”). In additional examples, the user device 102 may generate a modified version of a search query 208 (e.g., “Uber Posh Bagel San Jose”) by incorporating one or more terms associated with a first access URL (e.g., “Uber from current location to Posh Bagel San Jose Calif.”) and/or a second parameter (e.g., “Amarin Thai Cuisine Mountain View Calif.”) into the query 208, as previously described. In these examples, the user device 102 may also remove one or more other terms from the search query 208 (e.g., “Uber from current location to Amarin Thai Cuisine Mountain View Calif.,” or “Uber Amarin Thai Cuisine Mountain View Calif.”).

FIG. 8B is a flow diagram that illustrates a particular aspect of the example method 800A described with reference to FIG. 8A. For example, the operations of the example method 800B described with reference to FIG. 8B may be performed prior to performing the operations of the method 800A. As shown in FIG. 8B, in block 802B, the user device 102 may initially receive a second, different search query 208 from the user, in a similar manner as previously described. In block 804B, the user device 102 may transmit the second search query 208 to the search system 100, also in a similar manner as previously described. In this example, the search system 100 may receive the second search query 208 from the user device 102 and generate one or more search results 214, including the second search result 214, based on the query 208. In some examples, the search results 214 may include one or more access URLs, display data, result scores, and/or other information, in a similar manner as previously described. Additionally, or alternatively, the search results 214 may specify other content (e.g., native apps, web pages, documents, and/or media files). The search system 100 may then transmit the search results 214 to the user device 102.

As such, in block 806B, the user device 102 may receive the second search result 214 from the search system 100 in response to transmitting the second search query 208 to the system 100. In some examples, the user device 102 may also receive one or more additional ones of the search results 214 from the search system 100. As described herein, the second search result 214 may specify the second parameter. In some examples, the second search result 214 may include an access URL that specifies a state of a software app associated with a function performed based on the second parameter, in a similar manner as described with reference to the first search result 214. In other examples, the second search result 214 may correspond to other content (e.g., a native app, a web page, a document, and/or a media file) that specifies the second parameter. In additional examples, the second search result 214 may also include other information associated with the access URL or the other content, such as display data, result scores, and other information, also in a similar manner as previously described.

In block 808B, the user device 102, namely the search app 204, may display the second user-selectable link associated with the second search result 214. In some examples, the second user-selectable link may be configured to, upon being selected by a user input, cause the user device 102 to set a software app into a state specified by an access URL included in the second search result 214, in a similar manner as described with reference to the first user-selectable link. In other examples, the second user-selectable link may be configured to, upon being selected by a user input, cause the user device 102 to access other content (e.g., a native app, a web page, a document, and/or a media file) specified by the second search result 214. For example, the user device 102 may generate the second user-selectable link such that the link includes or indicates the access URL or the other content and, e.g., display data and/or other information received with the second search result 214 from the search system 100. The user device 102 may then display the second user-selectable link. In some examples, the user device 102 may also display one or more additional user-selectable links associated with one or more additional ones of the search results 214 received from the search system 100. In these examples, the user device 102 may further rank the displayed user-selectable links based on the corresponding result scores received with the search results 214 from the search system 100, also in a similar manner as described with reference to the first user-selectable link.

In block 810B, the user device 102, namely the search app 204, may receive a third, different user input from the user. In block 812B, in response to receiving the third user input, the user device 102, namely the search app 204, may store the second search result 214 and/or the second user-selectable link in an internal memory location or a remote data store. For example, the user device 102 may store the second search result 214 and/or the second user-selectable link on the device 102 and/or using cloud storage techniques. In block 814B, in response to receiving the first user input, as described with reference to the method 800A, the user device 102, namely the search app 204, may retrieve the stored second search result 214 and/or the second user-selectable link from the internal memory location or remote data store.

In general, the result of combining two or more user-selectable links in the manner described herein may vary depending on the corresponding search results 214 that are combined (e.g., the corresponding cards). As one example, the user may select, drag, and drop a user-selectable link specifying a recipe onto another user-selectable link associated with a shopping list or grocery store ordering function of a state of a software app. As another example, the user may select, drag, and drop a user-selectable link specifying a hotel onto another user-selectable link associated with a hotel booking function of a state of a software app. As still another example, the user may select, drag, and drop a user-selectable link specifying a restaurant onto another user-selectable link associated with a restaurant reservation function of a state of a software app. As yet another example, the user may select, drag, and drop a user-selectable link associated with a function for changing currency from one currency to another onto another user-selectable link. As a result, the user device 102, namely the search app 204, may transform all currencies specified by the other user-selectable link using the function. In some examples, the user may combine the first and second user-selectable links to generate the third user-selectable link in the manner described herein. The user may then further combine the third user-selectable link with one or more other user-selectable links and repeat the process as necessary.

In further examples, the search system 100 may generate one or more additional search results (not shown) that include content that does not specify states of software apps (e.g., content related to native apps, web pages, documents, and/or media files). In these examples, the search system 100 may identify one or more records, such as app records or other data structures, stored in a data store that include the content based on the search query 208, in a similar manner as described herein. The search system 100 may then select the content from the identified records and transmit the content to the user device 102 along with the search results 214.

The modules and data stores included in the search system 100 represent features that may be included in the system 100 as it is described in the present disclosure. For example, the search module 110, search data store 112, and result generation module 114 may represent features included in the search system 100. The modules and data stores may be embodied by electronic hardware, software, and/or firmware. Depiction of different features as separate modules and data stores does not necessarily imply whether the modules and data stores are embodied by common or separate electronic hardware, software, and/or firmware components. In general, the features associated with the modules and data stores may be realized by one or more common or separate electronic hardware, software, and/or firmware components.

The modules and data stores may be embodied by electronic hardware, software, and/or firmware components including, but not limited to, one or more processing units, memory components, input/output (I/O) components, and interconnect components. The interconnect components may be configured to provide communication between the processing units, memory components, and I/O components. For example, the interconnect components may include one or more buses configured to transfer data between electronic components. The interconnect components may also include control circuits (e.g., a memory controller and/or an I/O controller) configured to control communication between electronic components.

The processing units may include one or more central processing units (CPUs), graphics processing units (GPUs), digital signal processing units (DSPs), or other processing units. The processing units may be configured to communicate with the memory components and I/O components. For example, the processing units may be configured to communicate with the memory components and I/O components via the interconnect components.

A memory component, or memory, may include any volatile or non-volatile media. For example, the memory may include electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc, digital versatile disc, and/or Blu-ray disc), and/or any other memory components. The memory components may include, or store, the data described herein. For example, the memory components may store the data included in the state records 400A of the search data store 112 and/or other information. The memory components may also include instructions executed by the processing units. For example, the memory components may include computer-readable instructions that, when executed by the processing units, cause the units to perform the various functions attributed to the modules and data stores described herein.

The I/O components may refer to electronic hardware, software, and/or firmware that provide communication with a variety of different devices. For example, the I/O components may provide communication between other devices and the processing units and memory components. In some examples, the I/O components may be configured to communicate with a computer network. For example, the I/O components may be configured to exchange data over a computer network using a variety of different physical connections, wireless connections, and protocols. The I/O components may include network interface components (e.g., a network interface controller), repeaters, network bridges, network switches, routers, and firewalls. In some examples, the I/O components may include hardware, software, and/or firmware configured to communicate with various human interface devices, including display screens, keyboards, pointer devices (e.g., a mouse), touchscreens, speakers, and microphones. In other examples, the I/O components may include hardware, software, and/or firmware configured to communicate with additional devices, such as external memory (e.g., external HDDs).

In some examples, the search system 100 may be a system of one or more computing devices (e.g., a computer search system) configured to implement the techniques described herein. Put another way, the features attributed to the modules and data stores described herein may be implemented by one or more computing devices. Each computing device may include any combination of electronic hardware, software, and/or firmware described herein. For example, each computing device may include any combination of the processing units, memory components, I/O components, and interconnect components described herein. The computing devices may also include various human interface devices, including display screens, keyboards, pointing devices (e.g., a mouse), touchscreens, speakers, and microphones, and may also be configured to communicate with additional devices, such as external memory.

The computing devices may be configured to communicate with the network 106. The computing devices may also be configured to communicate with one another via a computer network. In some examples, the computing devices may include one or more server computing devices configured to communicate with the user device(s) 102 (e.g., receive search queries 208 and transmit search results 214), gather data from the data source(s) 104, index the data, store the data, and store other documents. In other examples, the computing devices may reside within a single machine at a single geographic location, within multiple machines at a single geographic location, or be distributed across a number of geographic locations.

Additionally, the various implementations of the search system 100 described herein (e.g., using one or more computing devices that include one or more processing units, memory components, I/O components, and interconnect components) are equally applicable to any of the user device(s) 102, as well as to the various components thereof.

What is claimed is:

1. A method comprising:
receiving, at a user device, a search query from a user;
transmitting, using the user device, the search query to a search system;
in response to transmitting the search query, receiving, at the user device, a first search result from the search system, wherein the first search result includes a first access uniform resource locator (URL) that specifies a first state of a software application (app), and wherein the first state is associated with a function performed based on a first parameter;
displaying, at the user device, a first user-selectable link associated with the first search result, wherein the first user-selectable link is configured to, upon being selected by a user input, cause the user device to set the software app into the first state;
receiving, at the user device, a first user input from the user;
in response to receiving the first user input, displaying, at the user device, a second, different user-selectable link associated with a second, different search result, wherein the second search result specifies a second, different parameter;
receiving, at the user device, a second, different user input selecting the first and second user-selectable links from the user; and
in response to receiving the second user input, displaying, at the user device, a third, different user-selectable link associated with the first and second search results, wherein the third user-selectable link is configured to, upon being selected by a user input, cause the user device to set the software app into a second, different state specified by a second, different access URL, and wherein the second state is associated with the function performed based on the second parameter.

2. The method of claim 1, wherein the second search result includes a third, different access URL that specifies a third, different state of a software app, wherein the third state is associated with a function performed based on the second parameter, and wherein the second user-selectable link is configured to, upon being selected by a user input, cause the user device to set the software app associated with the second search result into the third state.

3. The method of claim 1, wherein the search query comprises a first search query, the method further comprising:
receiving, at the user device, a second, different search query from the user;
transmitting, using the user device, the second search query to the search system;
in response to transmitting the second search query, receiving, at the user device, the second search result from the search system;
displaying, at the user device, the second user-selectable link;
receiving, at the user device, a third, different user input from the user; and
in response to receiving the third user input, storing, using the user device, one or more of the second search result and the second user-selectable link,
wherein displaying the second user-selectable link in response to receiving the first user input comprises retrieving, using the user device, the stored one or more of the second search result and the second user-selectable link.

4. The method of claim 1, wherein the second user input selecting the first and second user-selectable links comprises the second user input selecting the second user-selectable link, dragging the second user-selectable link toward the first user-selectable link, and dropping the second user-selectable link onto the first user-selectable link.

5. The method of claim 1, wherein the second user input selecting the first and second user-selectable links comprises the second user input substantially simultaneously selecting the first and second user-selectable links.

6. The method of claim 1, wherein the second user input comprises one or more user interactions with a user menu displayed at the user device, and wherein the one or more user interactions are configured to select the first and second user-selectable links.

7. The method of claim 1, wherein the first user-selectable link includes a portion associated with the first parameter, and wherein the second user input selecting the first user-selectable link comprises the second user input selecting the portion.

8. The method of claim 7, wherein the second user input selects the second user-selectable link, drags the second user-selectable link toward the first user-selectable link, and drops the second user-selectable link substantially onto the portion of the first user-selectable link associated with the first parameter.

9. The method of claim 1, further comprising determining, using the user device, whether the software app includes the second state.

10. The method of claim 9, wherein determining whether the software app includes the second state comprises one or more of the following:
performing a search for the second state in a data store associated with the software app;
performing a search for the second state in the software app executing on the user device;
querying an app programming interface (API) associated with the software app to determine whether the software app includes the second state; and
querying the search system to determine whether the search system includes a state record that specifies the second state.

11. The method of claim 9, further comprising displaying, at the user device, a graphical user interface (GUI) element indicating whether the software app includes the second state.

12. The method of claim 11, wherein displaying the GUI element comprises:
in the event the software app includes the second state, displaying a highlighted version of at least the first user-selectable link of the first and second user-selectable links; and
in the event the software app does not include the second state, displaying an unmodified version of each of the first and second user-selectable links.

13. The method of claim 11, wherein displaying the GUI element comprises:
in the event the software app includes the second state, displaying an unmodified version of each of the first and second user-selectable links; and
in the event the software app does not include the second state, displaying a grayed out version of at least the first user-selectable link of the first and second user-selectable links.

14. The method of claim 11, wherein displaying the GUI element comprises:
in the event the software app includes the second state, displaying a highlighted version of at least the first user-selectable link of the first and second user-selectable links; and
in the event the software app does not include the second state, displaying a grayed out version of at least the first user-selectable link of the first and second user-selectable links.

15. The method of claim 11, wherein displaying the GUI element comprises displaying the GUI element after displaying the second user-selectable link and otherwise refraining from displaying the GUI element.

16. The method of claim 11, wherein displaying the GUI element comprises displaying the GUI element while receiving the second user input and otherwise refraining from displaying the GUI element.

17. The method of claim 1, wherein displaying the third user-selectable link comprises displaying the third user-selectable link in place of the first user-selectable link.

18. The method of claim 1, further comprising generating, using the user device, the second access URL based on the first access URL and based on the second parameter, including inserting the second parameter into a field of the first access URL configured to include the first parameter.

19. The method of claim 1, further comprising generating, using the user device, the second access URL based on the first access URL and based on the second parameter, including:
generating a modified version of the search query based on the first access URL and based on the second parameter;
transmitting the modified version of the search query to the search system; and
in response to transmitting the modified version of the search query, receiving, at the user device, a third, different search result from the search system, wherein the third search result includes the second access URL.

20. A computing device comprising:
a network interface component configured to communicate with a network;
an input/output (I/O) component configured to receive a search query, a first user input, and a second, different user input from a user of the computing device;
a display;
one or more memory components configured to store computer-readable instructions; and
one or more processing units configured to execute the computer-readable instructions, wherein the computer-readable instructions, when executed by the one or more processing units, cause the one or more processing units to:
receive the search query from the user using the I/O component;
transmit the search query to a search system via the network using the network interface component;
in response to transmitting the search query, receive a first search result from the search system via the network using the network interface component, wherein the first search result includes a first access uniform resource locator (URL) that specifies a first state of a software application (app), and wherein the first state is associated with a function performed based on a first parameter;
display a first user-selectable link associated with the first search result using the display, wherein the first user-selectable link is configured to, upon being selected by a user input, cause the computing device to set the software app into the first state;
receive the first user input from the user using the I/O component;
in response to receiving the first user input, display a second, different user-selectable link associated with a second, different search result using the display, wherein the second search result specifies a second, different parameter;
receive the second user input selecting the first and second user-selectable links from the user using the I/O component; and
in response to receiving the second user input, display a third, different user-selectable link associated with the first and second search results using the display, wherein the third user-selectable link is configured to, upon being selected by a user input, cause the computing device to set the software app into a second, different state specified by a second, different access URL, and wherein the second state is associated with the function performed based on the second parameter.
